(19) United States
(12) Patent Application Publication
(10) Pub. No.: US 2026/0300748 A1
(43) Pub. Date: Oct. 1, 2026

(54) INCREASING EFFECTIVENESS OF AN AGENTIC AI FLOW BASED ON OUTPUT OF AN AI SUB-AGENT

(71) Applicant: Microsoft Technology Licensing, LLC, Redmond, WA (US)

(72) Inventors: Itay PELED, Tel Aviv (IL); Ian HELLEN, Seattle, WA (US); Shachaf LEVY, Zichron Yaacov (IL)

(21) Appl. No.: 19/090,338

(22) Filed: Mar. 25, 2025

(51) Int. Cl. G06N 3/092

(52) U.S. Cl. CPC G06N 3/092

(57) ABSTRACT

Techniques are described herein that are capable of increasing effectiveness of an agentic AI flow based on output of an AI sub-agent. An extent to which an input-output pair corresponds to a goal of an agentic AI flow that is implemented by AI sub-agents in an agentic AI system may be determined to provide a first factor. Extents to which intermediate input-output pairs of the AI sub-agents correspond to sub-tasks in the agentic AI flow may be determined to provide a second factor. An evaluation of an effectiveness of an invocation path of the agentic AI flow may be performed to provide a third factor. Score(s) are assigned to the invocation path and/or the AI sub-agents using the first, second, and/or third factors. The effectiveness of the invocation path is increased by reconfiguring the invocation path and/or by reconfiguring or replacing an AI sub-agent.

### BACKGROUND

An artificial intelligence (AI) system is a system that uses artificial intelligence to perform a task. An agentic AI system is an AI system that includes multiple AI sub-agents. The AI sub-agents are computer programs (e.g., standalone computer programs) that use artificial intelligence to perform respective sub-tasks, which are included in the task performed by the agentic AI system. An agentic AI flow is an operational flow of an agentic AI system. The agentic AI flow is defined by sub-tasks that are performed by AI sub-agents in the agentic AI system and coordinated interactions between subsets (e.g., pairs) of the AI sub-agents.

Evaluating an agentic AI flow of an agentic AI system typically is substantially more complex and time-consuming than evaluating an operational flow of a non-agentic AI system. A non-agentic AI system is an AI system that does not include multiple AI sub-agents. For example, evaluation of an agentic AI flow of an agentic AI system traditionally is performed manually by a team of information technology (IT) professionals. Each member of the team often manually performs a portion of the evaluation that corresponds to a respective AI sub-agent of the agentic AI system.

### SUMMARY

It may be desirable to improve an agentic AI flow of an agentic AI system by increasing effectiveness of an invocation path in the agentic AI flow. An invocation path in an agentic AI flow is a sequence of operations (e.g., steps or calls) that are performed in the agentic AI flow to achieve a goal of the agentic AI flow. The goal of the agentic AI flow corresponds to a task of an AI system. In an aspect, the sequence of operations in the agentic AI flow includes invocation of method(s), function(s), and/or service(s) in a particular order to achieve the goal of the agentic AI flow. The agentic AI flow may indicate (e.g., include) AI sub-agents in the AI system that perform the operations, tools that are used by the AI sub-agents to perform respective sub-tasks (e.g., respective subsets of the operations) that are included in the task of the AI system, an order in which the tools and/or the AI sub-agents are utilized, an estimated amount of time that is consumed by the AI sub-agents to complete the respective sub-tasks, whether the AI sub-agents implement a loop in the agentic AI flow, and so on.

Various approaches are described herein for, among other things, increasing effectiveness of an agentic AI flow based on output of an AI sub-agent. In a first example approach, an extent to which an input-output pair corresponds to a goal of an agentic AI flow, which is implemented by a plurality of AI sub-agents in an agentic AI system, is determined. The input-output pair comprises an AI input that is provided as an input to the agentic AI system and an AI response that is received as an output of the agentic AI system in response to the AI input. Extents to which intermediate input-output pairs of the AI sub-agents correspond to sub-tasks in the agentic AI flow that the AI sub-agents are responsible for performing are determined. The intermediate input-output pairs comprise inputs to the AI sub-agents and outputs that are received from the AI sub-agents in response to the inputs. Scores are assigned to the AI sub-agents using the extent to which the input-output pair corresponds to the goal of the agentic AI flow and the extents to which the intermediate input-output pairs of the AI sub-agents correspond to the sub-tasks that the AI sub-agents are responsible for performing. As a result of a first score that is assigned to a first AI sub-agent being less than a threshold score, the extent to which the intermediate input-output pair of the first AI sub-agent corresponds to a first sub-task that the first AI sub-agent is configured to perform is increased. The extent is increased by reconfiguring an AI algorithm that defines the first AI sub-agent. The AI sub-agents comprise the first AI sub-agent. The scores comprise the first score.

In a second example approach, An evaluation of an effectiveness with which an invocation path, which is utilized by a plurality of AI sub-agents in an agentic AI system to implement an agentic AI flow, achieves a goal of the agentic AI flow is performed. The evaluation is performed by analyzing attributes of the invocation path. The attributes of the invocation path comprise operations performed by the AI sub-agents to complete sub-tasks in the agentic AI flow that the AI sub-agents are responsible for completing. The attributes of the invocation path further comprise tools utilized by the AI sub-agents to perform at least a subset of the operations. A score is assigned to the invocation path using the evaluation of the effectiveness with which the invocation path achieves the goal of the agentic AI flow. As a result of the score that is assigned to the invocation path being less than a threshold score, the effectiveness with which the invocation path achieves the goal of the agentic AI flow is increased by reconfiguring the invocation path.

In a third example approach, an extent to which an input-output pair corresponds to a goal of an agentic AI flow, which is implemented by a plurality of AI sub-agents in an agentic AI system, is determined. The input-output pair comprises an AI input that is provided as an input to the agentic AI system and an AI response that is received as an output of the agentic AI system in response to the AI input. An evaluation of an effectiveness with which an invocation path, which is utilized by the agentic AI system to implement the agentic AI flow, achieves the goal of the agentic AI flow is performed. The evaluation is performed by analyzing attributes of the invocation path. The attributes of the invocation path comprise operations performed by the AI sub-agents to complete sub-tasks in the agentic AI flow that the AI sub-agents are responsible for completing. The attributes further comprise tools utilized by the AI sub-agents to perform at least a subset of the operations. Scores are assigned to the AI sub-agents using the extent to which the input-output pair corresponds to the goal of the agentic AI flow and the evaluation of the effectiveness with which the invocation path achieves the goal of the agentic AI flow. As a result of a first score that is assigned to a first AI sub-agent being less than a threshold score, the effectiveness with which the invocation path achieves the goal of the agentic AI flow is increased. The effectiveness is increased by replacing the first AI sub-agent with a replacement AI sub-agent. The AI sub-agents comprise the first AI sub-agent. The scores comprise the first score.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example AI sub-agent output-based effectiveness system in accordance with an embodiment.

FIGS. 2-6 depict flowcharts of example methods for increasing effectiveness of an agentic AI flow based on output of an AI sub-agent in accordance with embodiments.

FIG. 7 is a block diagram of an example computing system in accordance with an embodiment.

FIG. 8 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to improve an agentic AI flow of an agentic AI system by increasing effectiveness of an invocation path in the agentic AI flow. An invocation path in an agentic AI flow is a sequence of operations (e.g., steps or calls) that are performed in the agentic AI flow to achieve a goal of the agentic AI flow. The goal of the agentic AI flow corresponds to a task of an AI system. In an aspect, the sequence of operations in the agentic AI flow includes invocation of method(s), function(s), and/or service(s) in a particular order to achieve the goal of the agentic AI flow. The agentic AI flow may indicate (e.g., include) AI sub-agents in the AI system that perform the operations, tools that are used by the AI sub-agents to perform respective sub-tasks (e.g., respective subsets of the operations) that are included in the task of the AI system, an order in which the tools and/or the AI sub-agents are utilized, an estimated amount of time that is consumed by the AI sub-agents to complete the respective sub-tasks, whether the AI sub-agents implement a loop in the agentic AI flow, and so on.

An AI sub-agent includes or invokes one or more AI models. An AI model is a model that utilizes artificial intelligence to perform a task of an AI system or a sub-task of an AI sub-agent therein in response to an AI input that is received by the AI model. The AI model may be an artificial general intelligence model. An artificial general intelligence model is an AI model (e.g., an autonomous AI model) that is configured to be capable of performing any task that an intelligent being (e.g., a human) is capable of performing. In an example implementation, the artificial general intelligence model is capable of performing a task that surpasses the capabilities of an animal.

An AI input indicates (e.g., specifies) a task of an AI system or a sub-task of an AI sub-agent that is to be performed by an AI model. Examples of an AI input include but are not limited to an AI prompt and an application programming interface (API) input. An AI prompt is an AI input that causes an AI model to generate an answer that is responsive to the AI prompt. An answer to an AI prompt may be referred to as an AI response. Examples of an AI prompt include but are not limited to a zero-shot prompt, a one-shot prompt, and a few-shot prompt. A zero-shot prompt is a prompt that indicates a task or a sub-task to be performed by an AI model that has not been trained on example(s) of the task or the sub-task. A one-shot prompt is a prompt that includes a target prompt along with a single example prompt and a single example answer that is responsive to the single example prompt. The example prompt and the example answer provide guidance as to how the AI model is expected to respond to the target prompt. A few-shot prompt is a prompt that includes a target prompt along with multiple example prompts and multiple example answers that are responsive to the respective example prompts. The example prompts and the example answers provide guidance as to how the AI model is expected to respond to the target prompt.

An AI prompt may be a natural language prompt. A natural language prompt is a prompt that is written in a natural language. A natural language is a human language that has developed through use and repetition. For instance, the natural language may have developed naturally without conscious planning or premeditation. Examples of a natural language include English, French, Spanish, and Mandarin. In an aspect, the natural language prompt is generated by a user (e.g., a human). In another aspect, the natural language prompt is generated by a computing system (e.g., an AI assistant that runs on the computing system).

An AI prompt may not be written in a natural language. For instance, the AI prompt may include (e.g., be) computer code. The AI prompt may be any suitable sequence of characters that is capable of being interpreted by an AI model.

An API input is an AI input that is provided via an API to request a service or a function. An API is an interface between a computing system and code (e.g., software or firmware).

Example embodiments described herein are capable of increasing effectiveness of an agentic AI flow based on output of an AI sub-agent. Example techniques described herein have a variety of benefits as compared to conventional techniques for evaluating an agentic AI flow of an agentic AI system. For instance, the example techniques are capable of reducing an amount of time and/or resources (e.g., processor cycles, memory, network bandwidth) that is consumed (e.g., by a computing system) to evaluate an agentic AI flow of an agentic AI system and/or to improve the agentic AI flow. The example techniques are capable of improving the agentic AI flow by increasing efficiency of the agentic AI flow, increasing an extent to which an input-output pair of the agentic AI system corresponds to a goal of the agentic AI flow, increasing an extent to which an intermediate input-output pair of an AI sub-agent in the agentic AI system corresponds to a sub-task that the AI sub-agent is configured to perform, and/or increase an effectiveness with which an invocation path of the agentic AI flow achieves the goal of the agentic AI flow. The example techniques are capable of evaluating and/or improving the agentic AI flow with a greater statistical accuracy, precision, and/or reliability than conventional techniques.

By reducing the amount of time and/or resources that is consumed by a computing system to evaluate and/or improve an agentic AI flow of an agentic AI system, efficiency of the computing system may be increased. By reducing the amount of time and/or resources that is consumed by the computing system to evaluate and/or improve the agentic AI flow, a cost associated with evaluating and/or improving the agentic AI flow may be reduced.

In a first aspect, by determining an extent to which an input-output pair corresponds to a goal of an agentic AI flow that is implemented by a plurality of AI sub-agents in an agentic AI system; determining extents to which intermediate input-output pairs of the AI sub-agents correspond to sub-tasks in the agentic AI flow that the AI sub-agents are responsible for performing; assigning scores to the AI sub-agents using the extent to which the input-output pair corresponds to the goal of the agentic AI flow and the extents to which the intermediate input-output pairs of the AI sub-agents correspond to the sub-tasks that the AI sub-agents are responsible for performing; and/or increasing the extent to which the intermediate input-output pair of the first AI sub-agent corresponds to a first sub-task that the first AI sub-agent is configured to perform by reconfiguring an AI algorithm that defines the first AI sub-agent (e.g., as a result of a first score that is assigned to a first AI sub-agent being less than a threshold score), the amount of time and/or resources that is consumed by a computing system to evaluate and/or improve the agentic AI flow is reduced, the efficiency of the computing system is increased, and/or the cost associated with evaluating and/or improving the agentic AI flow is reduced.

In a second aspect, by determining an extent to which an input-output pair corresponds to a goal of an agentic AI flow that is implemented by a plurality of AI sub-agents in an agentic AI system; performing an evaluation of an effectiveness with which an invocation path, which is utilized by the plurality of AI sub-agents to implement the agentic AI flow, achieves the goal of the agentic AI flow by analyzing attributes of the invocation path; assigning a score to the invocation path using the extent to which the input-output pair corresponds to the goal of the agentic AI flow and/or the evaluation of the effectiveness with which the invocation path achieves the goal of the agentic AI flow; and/or increasing the effectiveness with which the invocation path achieves the goal of the agentic AI flow by reconfiguring the invocation path (as a result of the score that is assigned to the invocation path being less than a threshold score), the amount of time and/or resources that is consumed by a computing system to evaluate and/or improve the agentic AI flow is reduced, the efficiency of the computing system is increased, and/or the cost associated with evaluating and/or improving the agentic AI flow is reduced.

In a third aspect, by determining an extent to which an input-output pair corresponds to a goal of an agentic AI flow that is implemented by a plurality of AI sub-agents in an agentic AI system; performing an evaluation of an effectiveness with which an invocation path, which is utilized by the agentic AI system to implement the agentic AI flow, achieves the goal of the agentic AI flow by analyzing attributes of the invocation path; assigning scores to the AI sub-agents using the extent to which the input-output pair corresponds to the goal of the agentic AI flow and the evaluation of the effectiveness with which the invocation path achieves the goal of the agentic AI flow; and/or increasing the effectiveness with which the invocation path achieves the goal of the agentic AI flow by replacing a first AI sub-agent with a replacement AI sub-agent (e.g., as a result of a first score that is assigned to the first AI sub-agent being less than a threshold score), the amount of time and/or resources that is consumed by a computing system to evaluate and/or improve the agentic AI flow is reduced, the efficiency of the computing system is increased, and/or the cost associated with evaluating and/or improving the agentic AI flow is reduced.

The example techniques may automate at least some (e.g., all) aspects of evaluating and/or improving an agentic AI flow of an agentic AI system. For instance, the example techniques may automate any one or more (e.g., all) of the operations described above with regard to the first, second, and third aspects. By automating one or more of the operations described above with regard to the first, second, and third aspects, the example techniques reduce a number of the operations that are manually performed by an IT professional, which may enable the IT professional to focus on other tasks. By automating one or more of the operations described above with regard to the first, second, and third aspects, the example techniques reduce a cost of evaluating and/or improving the agentic AI flow. For instance, the example techniques may reduce a cost of increasing an effectiveness with which the invocation path of the agentic AI flow achieves the goal of the agentic AI flow. In an aspect, by automating an operation described above with regard to the first, second, or third aspect, the example embodiments may eliminate a cost associated with time that otherwise would have been spent by an information technology (IT) professional to manually perform the operation.

By reducing the amount of time and/or resources that is consumed by a computing system to evaluate and/or improve an agentic AI flow of an agentic AI system, the example techniques may increase a user experience and/or efficiency of an IT professional who develops, manages, or maintains the agentic AI system. The example techniques may increase a user experience and/or efficiency of an end user who uses the agentic AI system, for example, by improving the agentic AI flow (e.g., by increasing effectiveness of an invocation path of the agentic AI flow). The user experience of the IT professional and/or the end user may be increased in other ways, as well. For example, the user experience and/or the efficiency may be increased through a more statistically accurate, precise, and/or reliable evaluation and/or improvement of the agentic AI flow.

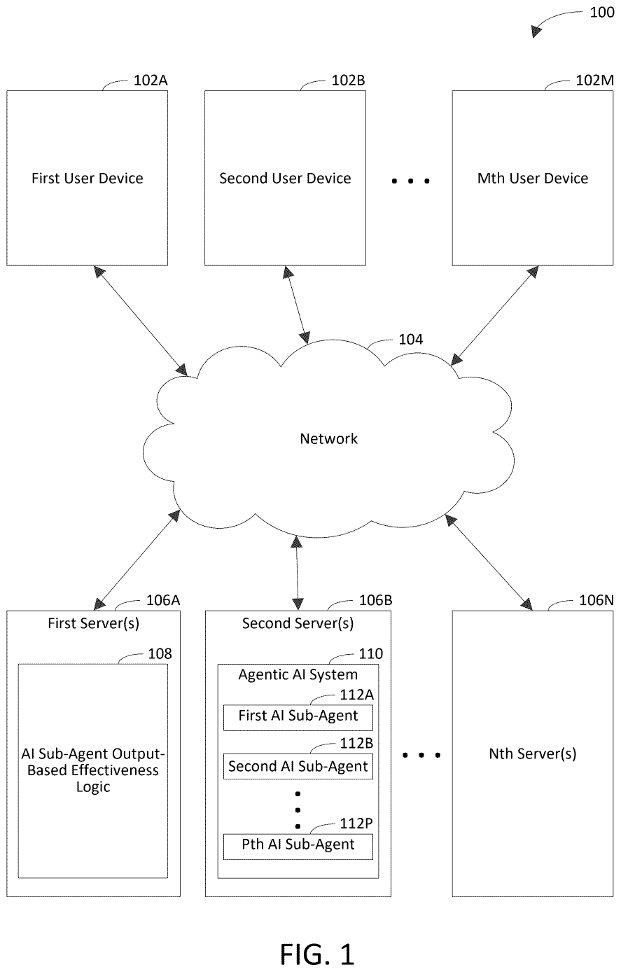

FIG. 1 is a block diagram of an example AI sub-agent output-based effectiveness system 100 in accordance with an embodiment. Generally speaking, the AI sub-agent output-based effectiveness system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the AI sub-agent output-based effectiveness system 100 increases effectiveness of an agentic AI flow based on output of an AI sub-agent. Detail regarding techniques for increasing effectiveness of an agentic AI flow based on output of an AI sub-agent is provided in the following discussion.

As shown in FIG. 1, the AI sub-agent output-based effectiveness system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the AI sub-agent output-based effectiveness system 100.

One example type of computer program that may be executed by one or more of the servers 106A-106N is a computer security program. A computer security program is a computer program that provides security with regard to information and/or communications associated with a computing system. For instance, the information associated with the computing system may include information stored on the computing system and/or information accessed (e.g., read) by the computing system. The communications associated with the computing system may include communications received by the computing system and/or communications provided (e.g., transmitted) by the computing system. An example of a communication is an electronic message. Examples of a computer security program include Bitdefender® security program, developed and distributed by Bitdefender IPR Management Ltd.; Norton® security program, developed and distributed by Gen Digital Inc.; Avast® security program, developed and distributed by Avast Software S.R.O.; McAfee® security program, developed and distributed by McAfee, LLC; and Microsoft Defender® security program, developed and distributed by Microsoft Corporation. It will be recognized that the example techniques described herein may be implemented using a computer security program. For instance, a software product (e.g., a subscription service, a non-subscription service, or a combination thereof) may include the computer security program, and the software product may be configured to perform the example techniques, though the scope of the example embodiments is not limited in this respect.

The computer security program may be a cloud native application protection platform (CNAPP). A CNAPP is an all-in-one platform that unifies security and compliance capabilities to prevent, detect, and respond to cloud security threats. A CNAPP integrates multiple cloud security solutions, which traditionally have been siloed, into a common (e.g., single) user interface. The cloud security solutions may include cloud security posture management (CSPM), multipipeline development and operations (DevOps) security, a cloud workload protection platform (CWPP), cloud infrastructure entitlement management (CIEM), and cloud service network security (CSNS). CSPM provides a connected, prioritized view of potential vulnerabilities and misconfigurations across multi-cloud and hybrid environments. The CSPM continuously assesses overall security posture of a system and provides automated alerts and recommendations about critical issues that could expose the system to data breaches. The CSPM may include automated compliance management and remediation tools to identify and remedy compliance deficiencies. Multipipeline DevOps security provides a central console that enables management of DevOps security across multiple (e.g., all) pipelines. For instance, the multipipeline DevOps security may be used to reduce cloud misconfigurations and to scan new code to keep vulnerabilities therein from reaching a production environment. The multipipeline DevOps security may include infrastructure-as-code scanning tools that analyze configuration files from the earliest stages of development to confirm that new configuration files are compliant with security policies. A CWPP provides real-time detection and response to threats based on up-to-date information regarding multi-cloud workloads (e.g., virtual machines, containers, Kubernetes, databases, storage accounts, network layers, and app services). The CWPP may enable a quick investigation into threats and reduce the attack surface of a system. CIEM centralizes permissions management across a cloud and hybrid footprint, which inhibits (e.g., prevents) accidental or malicious misuse of permissions. CSNS complements the CWPP by protecting cloud infrastructure in real time. The CSNS may include any of a variety of security tools, including but not limited to distributed denial-of-service protection, web application firewalls, transport layer security examination, and load balancing.

A computer security program may be incorporated into a cloud computing program (a.k.a. a cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). For example, IaaS may provide to the user virtualized computing resources that utilize the IaaS provider's physical computer resources.

Examples of a cloud computing program include but are not limited to a Google Cloud® program developed and distributed by Google Inc.; an Oracle Cloud® program developed and distributed by Oracle Corporation; an Amazon Web Services® program developed and distributed by Amazon.com, Inc.; a Salesforce® program developed and distributed by Salesforce.com, Inc.; an AppSource® program developed and distributed by Microsoft Corporation; an Azure® program developed and distributed by Microsoft Corporation; a GoDaddy® program developed and distributed by GoDaddy.com LLC; and a Rackspace® program developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include AI sub-agent output-based effectiveness logic 108 for illustrative purposes. The AI sub-agent output-based effectiveness logic 108 is configured to increase effectiveness of an agentic AI flow based on output of an AI sub-agent. In an aspect, the AI sub-agent is included in a plurality of AI sub-agents 112A-112P that are included in an agentic AI system 110 hosted by the second server(s) 106B.

In a first example approach, the AI sub-agent output-based effectiveness logic 108 determines an extent to which an input-output pair corresponds to a goal of an agentic AI flow. The agentic AI flow is implemented by the AI sub-agents 112A-112P in the agentic AI system 110. The input-output pair comprises an AI input that is provided as an input to the agentic AI system 110 and an AI response that is received as an output of the agentic AI system 110 in response to the AI input. The AI sub-agent output-based effectiveness logic 108 determines extents to which intermediate input-output pairs of the AI sub-agents 112A-112P correspond to sub-tasks in the agentic AI flow that the AI sub-agents 112A-112P are responsible for performing. The intermediate input-output pairs comprise inputs to the AI sub-agents 112A-112P and outputs that are received from the AI sub-agents 112A-112P in response to the inputs. The AI sub-agent output-based effectiveness logic 108 assigns scores to the AI sub-agents 112A-112P using the extent to which the input-output pair corresponds to the goal of the agentic AI flow and the extents to which the intermediate input-output pairs of the AI sub-agents 112A-112P correspond to the sub-tasks that the AI sub-agents 112A-112P are responsible for performing. As a result of a first score that is assigned to a first AI sub-agent being less than a threshold score, the AI sub-agent output-based effectiveness logic 108 increases the extent to which the intermediate input-output pair of the first AI sub-agent corresponds to a first sub-task that the first AI sub-agent is configured to perform. The AI sub-agent output-based effectiveness logic 108 increases the extent by reconfiguring an AI algorithm that defines the first AI sub-agent. The AI sub-agents 112A-112P comprise the first AI sub-agent. The scores comprise the first score.

In a second example approach, the AI sub-agent output-based effectiveness logic 108 performs an evaluation of an effectiveness with which an invocation path, which is utilized by a plurality of AI sub-agents in an agentic AI system 110 to implement an agentic AI flow, achieves a goal of the agentic AI flow. The AI sub-agent output-based effectiveness logic 108 performs the evaluation by analyzing attributes of the invocation path. The attributes of the invocation path comprise operations performed by the AI sub-agents 112A-112P to complete sub-tasks in the agentic AI flow that the AI sub-agents 112A-112P are responsible for completing. The attributes of the invocation path further comprise tools utilized by the AI sub-agents to perform at least a subset of the operations. The AI sub-agent output-based effectiveness logic 108 assigns a score to the invocation path using the evaluation of the effectiveness with which the invocation path achieves the goal of the agentic AI flow. As a result of the score that is assigned to the invocation path being less than a threshold score, the AI sub-agent output-based effectiveness logic 108 increases the effectiveness with which the invocation path achieves the goal of the agentic AI flow by reconfiguring the invocation path.

In a third example approach, the AI sub-agent output-based effectiveness logic 108 determines an extent to which an input-output pair corresponds to a goal of an agentic AI flow, which is implemented by the AI sub-agents 112A-112P in the agentic AI system 110. The input-output pair comprises an AI input that is provided as an input to the agentic AI system 110 and an AI response that is received as an output of the agentic AI system 110 in response to the AI input. The AI sub-agent output-based effectiveness logic 108 performs an evaluation of an effectiveness with which an invocation path, which is utilized by the agentic AI system 110 to implement the agentic AI flow, achieves the goal of the agentic AI flow. The AI sub-agent output-based effectiveness logic 108 performs the evaluation by analyzing attributes of the invocation path. The attributes of the invocation path comprise operations performed by the AI sub-agents 112A-112P to complete sub-tasks in the agentic AI flow that the AI sub-agents 112A-112P are responsible for completing. The attributes further comprise tools utilized by the AI sub-agents 112A-112P to perform at least a subset of the operations. Scores are assigned to the AI sub-agents 112A-112P using the extent to which the input-output pair corresponds to the goal of the agentic AI flow and the evaluation of the effectiveness with which the invocation path achieves the goal of the agentic AI flow. As a result of a first score that is assigned to a first AI sub-agent being less than a threshold score, the AI sub-agent output-based effectiveness logic 108 increases the effectiveness with which the invocation path achieves the goal of the agentic AI flow. The AI sub-agent output-based effectiveness logic 108 increases the effectiveness by replacing the first AI sub-agent with a replacement AI sub-agent. The AI sub-agents 112A-112P comprise the first AI sub-agent. The scores comprise the first score.

The second server(s) 106B are shown to include (e.g., host) the agentic AI system 110, which includes the AI sub-agents 112A-112P. Each of the AI sub-agents 112A-112P may utilize any one or more tools to perform a sub-task that the AI sub-agent is configured to perform. In an example, an AI sub-agent uses multiple tools to perform respective portions of its sub-task. In accordance with this example, the sub-task comprises multiple operations that define the respective portions. A tool is functionality (e.g., a sub-routine) that is configured to perform a particular type of operation. Example types of functionality include but are not limited to querying a database, executing code (e.g., an executable file), comparing particular types of data, and generating a particular type of output (e.g., a picture). A tool that includes functionality of an AI model is referred to herein as an “AI tool.” Each of multiple AI tools that are utilized by one or more of the AI sub-agents 112A-112P may include its own AI model, though the example embodiments are not limited in this respect. Examples of a particular type of operation that may be performed by functionality of an AI model include but are not limited to random forest learning, isolation forest anomaly detection, naïve Bayes classification, K-nearest neighbors classification, K-nearest neighbors regression, gradient boosting, support vector machine (SVM) classification, linear regression, nonlinear regression, Poisson regression, quantile regression, nonparametric regression, stratified random sampling, cluster random sampling, systematic random sampling, frequency analysis, and P-value analysis.

Random forest learning is a supervised ensemble learning technique that uses multiple decision trees to determine likelihoods of outcomes (e.g., to make predictions). The random forest learning technique includes building the multiple decision trees (a.k.a. a forest of decision trees), training each decision tree on a respective random subset of data, and aggregating outputs (e.g., predictions) of the respective decision trees to provide an output of the random forest learning technique.

Isolation forest anomaly detection is an unsupervised anomaly detection technique that is configured to identify outliers (a.k.a. anomalies) in a dataset. The isolation forest anomaly detection technique isolates observations by randomly selecting a feature and randomly selecting a split value in a range of the feature. A relatively shorter path indicates an anomaly.

Naïve Bayes classification is a supervised classification technique that determines (e.g., predicts) a probability of an instance belonging to a class based on specified feature values. The naïve Bayes classification technique assumes that features having the specified feature values are conditionally independent for the class.

K-nearest neighbors classification classifies an unlabeled data point to the class that is most common among its K nearest neighbors. K is a positive integer.

K-nearest neighbors regression estimates (e.g., predicts) an average value of a property based on values of its K nearest neighbors.

Gradient boosting is an ensemble learning technique that combines multiple weak learners (e.g., decision trees) to create a stronger model. The gradient boosting technique starts with an initial value (e.g., a mean of a target variable), and subsequent models are trained to minimize residual errors (i.e., differences between actual and estimated (e.g., predicted) values. Gradient boosting can be used for classification and regression.

SVM classification is a supervised classification technique that is configured to identify the largest gap between data points of different classes.

Linear regression estimates a linear relationship between a dependent variable and one or more independent variables. The linear regression technique is configured to identify the best-fitting line that represents a general trend of a dataset.

Nonlinear regression fits data to a mathematical function that does not follow a straight line.

Poisson regression analyzes count data by modeling a log-linear relationship between predictors (i.e., features) and expected counts. The Poisson regression technique assumes that a response variable Y has a Poisson distribution and that a logarithm of an expected value of Y can be modeled by a linear combination of unknown parameters.

Quantile regression estimates conditional quantiles (e.g., median, quartiles) of a response variable.

Nonparametric regression is a regression technique in which a predictor (i.e., feature) does not assume a predefined form. Rather, the nonparametric regression technique constructs a relationship between predictors and a dependent variable based on data information.

Stratified random sampling is a sampling technique in which a dataset is divided into homogeneous subsets based on respective attributes. Each data point of the dataset is included in a single homogeneous subset. A random sample is selected from each homogeneous subset using another sampling technique.

Cluster random sampling is a sampling technique in which a dataset is divided into clusters, and data points are randomly selected from the clusters to form a sample.

Systematic random sampling is a sampling technique in which data points are selected from a dataset at regular predefined intervals to form a sample.

Frequency analysis is a technique that determines a frequency with which a data point occurs in a dataset.

P-value analysis is a technique that determines a probability value (a.k.a. a p-value) indicating a likelihood that observed data could have occurred under the null hypothesis. The null hypothesis is that no relationship exists between variables of interest or no difference exists among groups. A relatively low p-value indicates that the observed data is inconsistent with the null hypothesis, which may indicate that another hypothesis may be better supported by the observed data. A relatively high p-value indicates that the observed data is consistent with the null hypothesis.

By focusing on a particular sub-task that is included in a task performed by the agentic AI system 110, an AI sub-agent in the agentic AI system 110 may be capable of performing the particular sub-task with a greater statistical accuracy, precision, and/or reliability than a more generic computer program (e.g., a non-agentic AI system) that is configured to perform more (e.g., all) of the sub-tasks that are included in the task. The AI agents 112A-112P performing their particular sub-tasks with a greater statistical accuracy, precision, and/or reliability than the more generic computer program may enable the agentic AI system 110 to perform its task with a greater statistical accuracy, precision, and/or reliability than the more generic computer program.

An AI sub-agent (e.g., any of the AI sub-agents 112A-112P) may be an autonomous AI sub-agent. An autonomous AI sub-agent is a an AI sub-agent that is configured to select one or more AI tools of an AI model (e.g., in real-time) based on one or more factors to perform a sub-task (e.g., one or more operations in the sub-task). For instance, the autonomous AI sub-agent may select first AI tool(s) of the AI model based on existence of first factor(s) to perform a first operation of the sub-task. The autonomous AI sub-agent may select second AI tool(s) of the AI model based on existence of second factor(s) to perform a second operation of the sub-task, and so on. The autonomous AI sub-agent may use multiple AI tools simultaneously to obtain respective results, and the autonomous AI sub-agent may select the most common result among those results to serve as an output of the autonomous AI sub-agent. By referring to AI sub-agents as “autonomous,” it is meant that each of the AI sub-agents is capable of operating in absence of the other AI sub-agents. Nevertheless, output of any one or more autonomous AI sub-agents may be used as input to any one or more other autonomous AI sub-agents.

The AI sub-agent output-based effectiveness logic 108 may be implemented in various ways to increase effectiveness of an agentic AI flow based on output of an AI sub-agent, including being implemented in hardware, software, firmware, or any combination thereof. For example, the AI sub-agent output-based effectiveness logic 108 may be implemented as computer program code configured to be executed in one or more processors. In another example, at least a portion of the AI sub-agent output-based effectiveness logic 108 may be implemented as hardware logic/electrical circuitry. For instance, at least a portion of the AI sub-agent output-based effectiveness logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the AI sub-agent output-based effectiveness logic 108 may be (or may be included in) a computer security program and/or a cloud computing program, though the scope of the example embodiments is not limited in this respect.

The AI sub-agent output-based effectiveness logic 108 is shown to be incorporated in the first server(s) 106A for illustrative purposes and is not intended to be limiting. It will be recognized that the AI sub-agent output-based effectiveness logic 108 (or any portion(s) thereof) may be incorporated in any one or more of the servers 106A-106N, any one or more of the user devices 102A-102M, or any combination thereof. For example, client-side aspects of the AI sub-agent output-based effectiveness logic 108 may be incorporated in one or more of the user devices 102A-102M, and server-side aspects of AI sub-agent output-based effectiveness logic 108 may be incorporated in one or more of the servers 106A-106N.

The agentic AI system 110 is shown to be incorporated in the second server(s) 106B for illustrative purposes and is not intended to be limiting. It will be recognized that the agentic AI system 110 (or any portion(s) thereof) may be incorporated in any one or more of the servers 106A-106N, any one or more of the user devices 102A-102M, or any combination thereof. For example, client-side aspects of the agentic AI system 110 may be incorporated in one or more of the user devices 102A-102M, and server-side aspects of agentic AI system 110 may be incorporated in one or more of the servers 106A-106N.

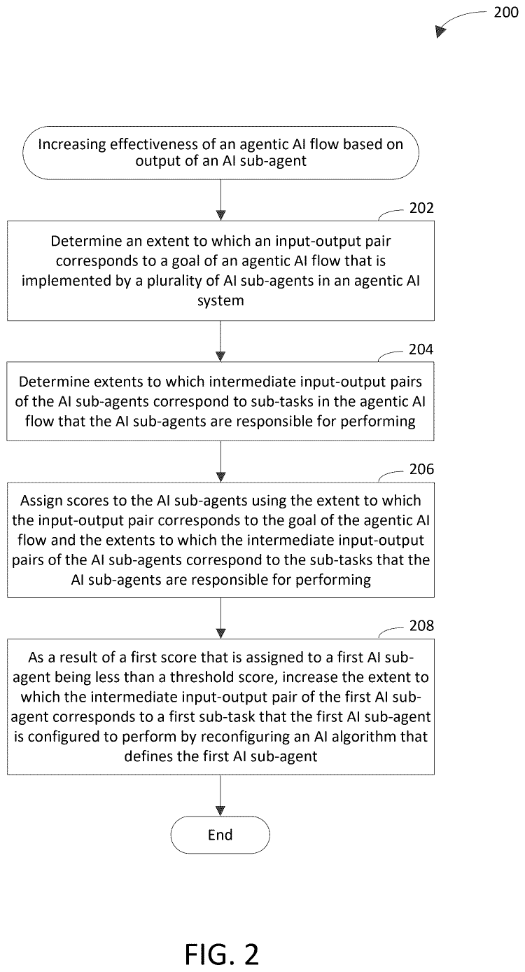

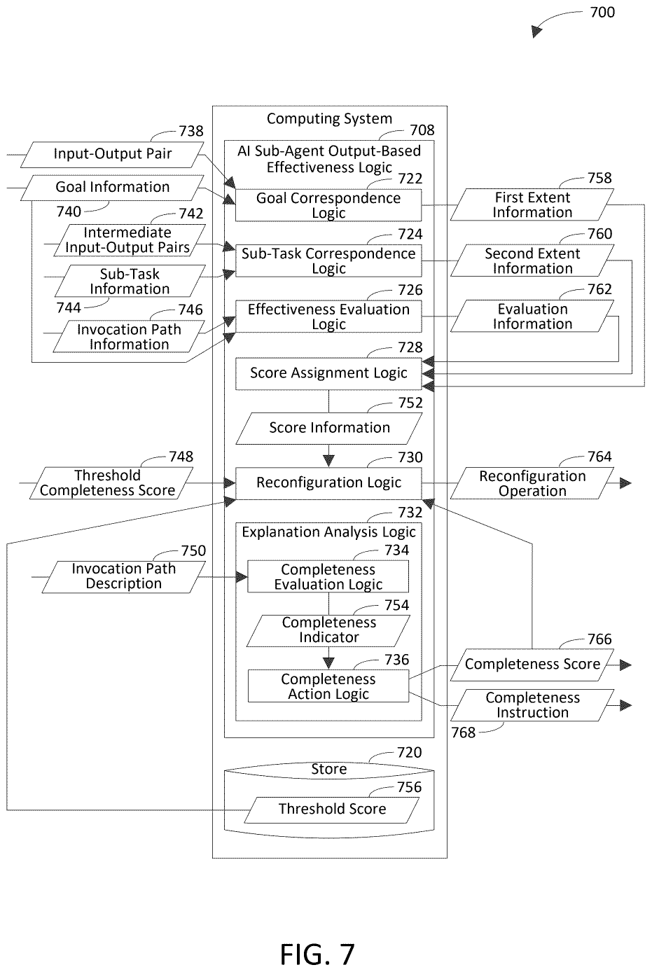

FIGS. 2-6 depict flowcharts 200, 300, 400, 500, and 600 of example methods for increasing effectiveness of an agentic AI flow based on output of an AI sub-agent in accordance with embodiments. Flowcharts 200, 300, 400, 500, and 600 may be performed by the first server(s) 106A shown in FIG. 1, for example. For illustrative purposes, flowcharts 200, 300, 400, 500, and 600 are described with respect to a computing system 700 shown in FIG. 7, which is an example implementation of the first server(s) 106A. As shown in FIG. 7, the computing system 700 includes AI sub-agent output-based effectiveness logic 708 and a store 720. The AI sub-agent output-based effectiveness logic 708 includes goal correspondence logic 722, sub-task correspondence logic 724, effectiveness evaluation logic 726, score assignment logic 728, reconfiguration logic 730, and explanation analysis logic 732. The explanation analysis logic 732 includes completeness evaluation logic 734 and completeness action logic 736. The store 720 may be any suitable type of store. One type of store is a database. For instance, the store 720 may be a relational database, an entity-relationship database, an object database, an object relational database, an extensible markup language (XML) database, etc. The store 720 is shown to store a threshold score 756 for non-limiting, illustrative purposes. Further structural and operational embodiments will be apparent to persons skilled in the relevant art(s) based on the discussion regarding flowcharts 200, 300, 400, 500, and 600.

As shown in FIG. 2, the method of flowchart 200 begins at step 202. In step 202, an extent to which an input-output pair corresponds to a goal of an agentic AI flow is determined. The agentic AI flow is implemented by a plurality of AI sub-agents (e.g., AI algorithms that define the AI sub-agents) in an agentic AI system. The input-output pair comprises an AI input that is provided as an input to the agentic AI system and an AI response that is received as an output of the agentic AI system in response to the AI input.

In an aspect, the extent to which the input-output pair corresponds to the goal of the agentic AI flow indicates completeness, accuracy, and/or usefulness of the AI response. The completeness of the AI response is a thoroughness with which the AI response addresses the AI input. For instance, the completeness may be based at least on an amount of detail and/or comprehensiveness that content of the AI response includes with regard to the AI input. The accuracy of the AI response is a correctness of the content of the AI response. For instance, the accuracy may be based at least on factual correctness of the content, a number of errors in the content, and/or reliability of a source from which at least a portion of the content is received. The usefulness of the AI response is an estimation of helpfulness of the AI response to a user from whom the AI input is received. For instance, the usefulness may be based at least on relevance of the AI response to a need of the user, clarity of the content of the AI response, coherence of the content of the AI response, and/or readability of the content.

In another aspect, the input-output pair is represented using a first vector, and the goal of the agentic AI flow is represented using a second vector. In accordance with this aspect, the extent to which the input-output pair corresponds to the goal of the agentic AI flow is based at least on a distance between the first vector and the second vector. In further accordance with this aspect, a shorter distance between the first and second vectors indicates that the input-output pair corresponds to the goal of the agentic AI flow to a greater extent, whereas a greater distance between the first and second vectors indicates that the input-output pair corresponds to the goal of the agentic AI flow to a lesser extent. For example, the extent to which the input-output pair corresponds to the goal of the agentic AI flow may be in a range between 80% and 100%, in a range between 90% and 100%, or in a range between 95% and 100%. In another example, the extent to which the input-output pair corresponds to the goal of the agentic AI flow may be 85%, 95%, or 98%.

In yet another aspect, the agentic AI flow is a nondeterministic agentic AI flow. A nondeterministic agentic AI flow of an agentic AI system is an agentic AI flow for which AI sub-agents of the agentic AI system are capable of being chosen by the agentic AI system and each of the AI sub-agents is capable of choosing its own tool(s) to perform its sub-task.

In an example implementation, the goal correspondence logic 722 determines an extent to which an input-output pair 738 corresponds to a goal of the agentic AI flow. The input-output pair 738 comprises the AI input, which is provided as the input to the agentic AI system, and the AI response, which is received as the output of the agentic AI system. In an aspect, the goal correspondence logic 722 analyzes goal information 740, which indicates the goal of the agentic AI flow, to determine the goal. The goal correspondence logic 722 generates first extent information 758, which indicates the extent to which the input-output pair 738 corresponds to the goal of the agentic AI flow. In an aspect, the first extent information 758 includes a real number in a range from zero to one. In accordance with this aspect, the real number being zero indicates no (e.g., 0%) correspondence between the input-output pair 738 and the goal of the agentic AI flow. In further accordance with this aspect, the real number being one indicates a complete (e.g., 100%) correspondence between the input-output pair 738 and the goal of the agentic AI flow.

In an example embodiment, the extent to which the input-output pair corresponds to the goal of the agentic AI flow takes into consideration whether the AI response comprises an error. An error in an AI response is an inaccurate statement in the AI response or an invalid statement in the AI response. An inaccurate statement in an AI response is a statement in the AI response that is incorrect or misleading. An invalid statement in an AI response is a statement that lacks a factual basis. For instance, the invalid statement may be fabricated.

In another example embodiment, the extent to which the input-output pair corresponds to the goal of the agentic AI flow takes into consideration a number of hallucinations that are comprised in the AI response. A hallucination in an AI response is information that is incorrect, misleading, or lacks a factual basis (e.g., is fabricated).

In yet another example embodiment, the extent to which the input-output pair corresponds to the goal of the agentic AI flow takes into consideration a number of instances of required information that are omitted from the AI response. The instances of the required information are instances of information that are required to achieve the goal of the agentic AI flow.

In still another example embodiment, determining the extent to which the input-output pair corresponds to the goal of the agentic AI flow at step 204 comprises determining clarity of the AI response by analyzing the AI response with reference to a clarity standard. The clarity of the AI response is an estimation of understandability of the AI response to a user from whom the AI input is received. In an aspect, the understandability of the AI response is based at least on readability of the AI response as evaluated using a readability test. Examples of a readability test include but are not limited to a Flesch-Kincaid readability test, a Gunning Fog Index test, a Simple Measure of Gobbledygook (SMOG) Index test, a Dale-Chall Readability Formula test, a Coleman-Liau Index test, and an Automated Readability Index (ARI) test. In an aspect, the clarity standard requires that the AI response include an amount of active voice that is greater than or equal to an amount threshold and/or a proportion of active verbs among verbs in the AI response that is greater than or equal to a proportion threshold. For instance, the amount threshold and/or the proportion threshold may be 80%, 90%, or 95%. In accordance with this embodiment, determining the extent to which the input-output pair corresponds to the goal of the agentic AI flow at step 204 further comprises determining the extent to which the input-output pair corresponds to the goal of the agentic AI flow by taking into consideration the clarity of the AI response.

In another example embodiment, determining the extent to which the input-output pair corresponds to the goal of the agentic AI flow comprises determining usefulness of the AI response by analyzing the AI response with reference to a usefulness standard. In an aspect, the usefulness standard requires relevance of the AI response to a need of the user to be greater than or equal to a relevance threshold, clarity of the content of the AI response to be greater than or equal to a clarity threshold, coherence of the content of the AI response to be greater than or equal to a coherence threshold, and/or readability of the content to be greater than or equal to a readability threshold. For instance, the relevance threshold, the clarity threshold, the coherence threshold, and/or the readability threshold may be 80%, 90%, or 95%. In accordance with this embodiment, determining the extent to which the input-output pair corresponds to the goal of the agentic AI flow further comprises determining the extent to which the input-output pair corresponds to the goal of the agentic AI flow by taking into consideration the usefulness of the AI response.

At step 204, extents to which intermediate input-output pairs of the AI sub-agents correspond to sub-tasks in the agentic AI flow are determined. The AI sub-agents are responsible for performing the sub-tasks. For instance, the AI sub-agents may be configured to perform the sub-tasks. In an example, a first AI sub-agent has a first intermediate input-output pair and is responsible for performing a first sub-task in the agentic AI flow; a second AI sub-agent has a second intermediate input-output pair and is responsible for performing a second sub-task in the agentic AI flow, and so on. In an aspect, the sub-tasks are indicated (e.g., defined) by ground truths. A ground truth is information that is known to be true. In an example, the ground truth is provided by direct observation and/or measurement. In another example, the ground truth is provided by empirical evidence, rather than inferential evidence. The intermediate input-output pairs comprise inputs to the AI sub-agents and outputs that are received from the AI sub-agents in response to the inputs.

In an example implementation, the sub-task correspondence logic 724 determines extents to which intermediate input-output pairs 742 of the AI sub-agents correspond to the sub-tasks in the agentic AI flow that the AI sub-agents are responsible for performing. The intermediate input-output pairs 742 comprise the inputs to the AI sub-agents and the outputs that are received from the AI sub-agents in response to the inputs. The sub-task correspondence logic 724 generates second extent information 760, which indicates the extents to which the intermediate input-output pairs 742 of the AI sub-agents correspond to the sub-tasks in the agentic AI flow that the AI sub-agents are responsible for performing.

In an aspect of this implementation, sub-task information 744 indicates the sub-tasks in the agentic AI flow that the AI sub-agents are responsible for performing. In an example, the sub-task information 744 specifies the sub-tasks, specifies the AI sub-agents, and cross-references the sub-tasks to the AI sub-agents that are responsible for performing the sub-tasks. In an implementation of this example, the sub-task correspondence logic 724 analyzes the sub-task information 744 to identify the sub-tasks and then identifies the AI sub-agents that are responsible for performing the sub-tasks by using the sub-task information 744 to cross-reference the sub-tasks with the AI sub-agents. In another implementation of this example, the sub-task correspondence logic 724 analyzes the sub-task information 744 to identify the AI sub-agents. In accordance with this implementation, the sub-task correspondence logic 724 identifies the sub-tasks that the AI sub-agents are responsible for performing by using the sub-task information 744 to cross-reference the AI sub-agents with the sub-tasks.

In an example embodiment, an extent to which an intermediate input-output pair of an AI sub-agent corresponds to a sub-task in the agentic AI flow that the AI sub-agent is responsible for performing takes into consideration whether an output that is received from the AI sub-agent in response to an input to the AI sub-agent comprises an error. An error in an output is inaccurate information in the output or invalid information in the output. Inaccurate information in an output is information in the output that is incorrect or misleading. Invalid information in an output is information that lacks a factual basis. For instance, the invalid information may be fabricated.

In another example embodiment, an extent to which an intermediate input-output pair of an AI sub-agent corresponds to a sub-task in the agentic AI flow that the AI sub-agent is responsible for performing takes into consideration a number of hallucinations that are comprised in an output that is received from the AI sub-agent in response to an input to the AI sub-agent. A hallucination in an output is information that is incorrect, misleading, or lacks a factual basis (e.g., is fabricated).

In yet another example embodiment, an extent to which an intermediate input-output pair of an AI sub-agent corresponds to a sub-task in the agentic AI flow that the AI sub-agent is responsible for performing takes into consideration a number of instances of required information that are omitted from an output that is received from the AI sub-agent in response to an input to the AI sub-agent. The instances of the required information are instances of information that are required to complete a sub-task in the agentic AI flow that the AI sub-agent is responsible for performing.

In still another example embodiment, step 204 comprises determining clarity of the outputs that are received from the AI sub-agents by analyzing the outputs that are received from the AI sub-agents with reference to a clarity standard. In accordance with this embodiment, the extents to which intermediate input-output pairs of the AI sub-agents correspond to sub-tasks in the agentic AI flow that the AI sub-agents are responsible for performing are determined by taking into consideration the clarity of the outputs that are received from the AI sub-agents.

In an example embodiment, step 204 comprises determining usefulness of the outputs that are received from the AI sub-agents by analyzing the outputs that are received from the AI sub-agents with reference to a usefulness standard. In accordance with this embodiment, the extents to which intermediate input-output pairs of the AI sub-agents correspond to sub-tasks in the agentic AI flow that the AI sub-agents are responsible for performing are determined by taking into consideration the usefulness of the outputs that are received from the AI sub-agents.

At step 206, scores are assigned to the AI sub-agents using the extent to which the input-output pair corresponds to the goal of the agentic AI flow and the extents to which the intermediate input-output pairs of the AI sub-agents correspond to the sub-tasks that the AI sub-agents are responsible for performing. In an aspect, the scores indicate usefulness of the AI sub-agents. In an example, a first score indicates a first usefulness of a first AI sub-agent; a second score indicates a second usefulness of a second AI sub-agent, and so on. The usefulness of an AI sub-agent is an estimation of helpfulness of the AI sub-agent to a user from whom the AI input is received. For instance, the usefulness may be based at least on relevance of the output of the AI sub-agent to the task of the AI system, accuracy (statistical accuracy) of the output with regard to the input, and/or completeness (e.g., statistical completeness) of the output with regard to the input.

In an example implementation, the score assignment logic 728 assigns scores to the AI sub-agents using the extent to which the input-output pair 738 corresponds to the goal of the agentic AI flow and the extents to which the intermediate input-output pairs 742 of the AI sub-agents correspond to the sub-tasks that the AI sub-agents are responsible for performing. In an aspect, the score assignment logic 728 analyzes the first extent information 758 to determine the extent to which the input-output pair 738 corresponds to the goal of the agentic AI flow. In accordance with this aspect, the score assignment logic 728 analyzes the second extent information 760 to determine the extents to which the intermediate input-output pairs 742 of the AI sub-agents correspond to the sub-tasks in the agentic AI flow that the AI sub-agents are responsible for performing. In further accordance with this aspect, the score assignment logic 728 assigns the scores to the AI sub-agents using the first extent information 758 and the second extent information 760. The score assignment logic 728 generates score information 752, which indicates the scores. In an example, the score information 752 specifies the AI sub-agents, specifies the scores, and cross-references the AI sub-agents to the scores that are assigned to the AI sub-agents.

At step 208, as a result of a first score that is assigned to a first AI sub-agent being less than a threshold score, the extent to which the intermediate input-output pair of the first AI sub-agent corresponds to a first sub-task that the first AI sub-agent is configured to perform is increased by reconfiguring an AI algorithm that defines the first AI sub-agent. The AI sub-agents comprise the first AI sub-agent. The scores comprise the first score. In an aspect, the first score is in a range between zero and one. In accordance with this aspect, the threshold score may be 0.8 (e.g., 80%), 0.9 (e.g., 90%), or 0.95 (e.g., 95%). In another aspect, reconfiguring the AI algorithm comprises modifying code that defines functionality of the AI algorithm. In an example of this aspect, modifying the code comprises refining the functionality of the AI algorithm (e.g., adding detail to an existing sub-routine in the code), expanding the functionality of the AI algorithm (e.g., adding a sub-routine to the code), and/or replacing a portion of the functionality with replacement functionality (e.g., replacing an existing sub-routine in the code with a replacement sub-routine). In an example implementation, as a result of the first score that is assigned to the first AI sub-agent being less than the threshold score 756, the reconfiguration logic 730 increases the extent to which the intermediate input-output pair of the first AI sub-agent corresponds to the first sub-task that the first AI sub-agent is configured to perform by performing a reconfiguration operation 764. The reconfiguration operation 764 comprises reconfiguring an AI algorithm that defines the first AI sub-agent.

In an example embodiment, any one or more (e.g., all) of steps 202, 204, 206, and/or 208 are performed in real-time as the agentic AI flow is being implemented by the plurality of AI sub-agents in the agentic AI system (i.e., as the task is being performed by the agentic AI system). For instance, performing any one or more of the steps 202, 204, 206, and/or 208 in real-time may result in the intermediate input-output pair of the first AI sub-agent corresponding to the first sub-task, which the first AI sub-agent is configured to perform, to a greater extent, as compared to a scenario in which the steps 202, 204, 206, and 208 are performed after implementation of the agentic AI flow is completed.

In another example embodiment, steps 202, 204, 206, and 208 are performed after implementation of the agentic AI flow is completed (i.e., after performance of the task by the agentic AI system is completed). For instance, performing steps 202, 204, 206, and 208 after implementation of the agentic AI flow is completed may result in the agentic AI flow being implemented more quickly or at a lower cost than a scenario in which one or more of the steps 202, 204, 206, and/or 208 are performed in real-time.

In some example embodiments, one or more steps 202, 204, 206, and/or 208 of flowchart 200 may not be performed. Moreover, steps in addition to or in lieu of steps 202, 204, 206, and/or 208 may be performed. For instance, in an example embodiment, the method of flowchart 200 further includes performing an evaluation of an effectiveness with which an invocation path achieves the goal of the agentic AI flow. The invocation path is utilized by the agentic AI system to implement the agentic AI flow. The evaluation is performed by analyzing attributes of the invocation path. The attributes of the invocation path comprise operations performed by the AI sub-agents to execute sub-tasks in the agentic AI flow that the AI sub-agents are responsible for executing and tools utilized by the AI sub-agents to perform at least a subset of the operations. In an example implementation, the effectiveness evaluation logic 726 performs the evaluation of the effectiveness with which the invocation path achieves the goal of the agentic AI flow. In an aspect, invocation path information 746 indicates attributes of the invocation path. In accordance with this aspect, the effectiveness evaluation logic 726 analyzes the invocation path information 746 to determine the attributes of the invocation path. In further accordance with this aspect, the effectiveness evaluation logic 726 performs the evaluation by taking into consideration the attributes that are indicated by the invocation path information 746. The effectiveness evaluation logic 726 generates evaluation information 762, which indicates (e.g., specifies) the effectiveness with which the invocation path achieves the goal of the agentic AI flow. In accordance with this embodiment, the scores are assigned to the AI sub-agents at step 206 using the extent to which the input-output pair corresponds to the goal of the agentic AI flow, the evaluation of the effectiveness with which the invocation path achieves the goal of the agentic AI flow, and the evaluation of the effectiveness with which the invocation path achieves the goal of the agentic AI flow. In an example implementation, the score assignment logic 728 assigns the scores to the AI sub-agents using the extent to which the input-output pair 738 corresponds to the goal of the agentic AI flow, as indicated by first extent information 758; the extents to which the intermediate input-output pairs 742 of the AI sub-agents correspond to the sub-tasks that the AI sub-agents are responsible for performing, as indicated by the second extent information 760; and the evaluation of the effectiveness with which the invocation path achieves the goal of the agentic AI flow, as indicated by the evaluation information 762.

In an aspect of this embodiment, the attributes of the invocation path further comprise an order of the operations performed by the AI sub-agents to execute the sub-tasks in the agentic AI flow that the AI sub-agents are responsible for executing.

In another aspect of this embodiment, performing the evaluation of the effectiveness with which the invocation path achieves the goal of the agentic AI flow comprises determining whether identified operations cause the invocation path to comprise an iterative loop. The operations performed by the AI sub-agents comprise the identified operations. An iterative loop is a set of operations that are repeatedly performed. For instance, the set of operations may be defined by portions of code that are repeatedly executed. In an example, the set of operations that define the iterative loop are repeatedly performed so long as a specified condition is satisfied. In an implementation of this example, the iterative loop is a while loop. A while loop is an iterative loop in which operations are performed so long as a specified condition is true. In another implementation of this example, the iterative loop is a do-while loop. A do-while loop is an iterative loop in which operations are performed so long as a specified condition is true, and the operations are performed at least once before the condition is tested. In another example, the set of operations that define the iterative loop are repeatedly performed regardless whether a condition is satisfied. For instance, the iterative loop may be an infinite loop. An infinite loop is an iterative loop having a set of operations that repeat without a specified ending condition. An ending condition of an iterative loop is a condition that, when satisfied, triggers an end of the iterative loop.

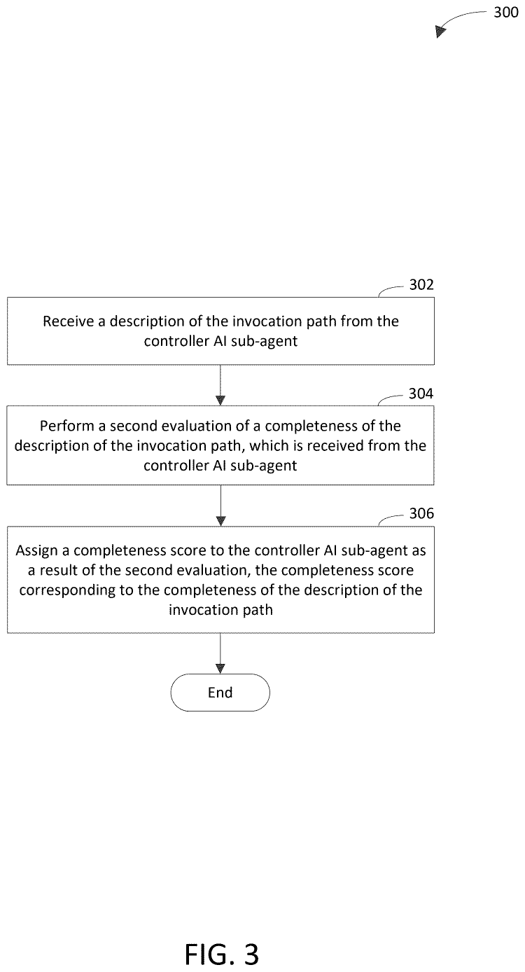

In yet another aspect of this embodiment, the invocation path is established by a controller AI sub-agent that coordinates execution of the AI sub-agents and that is comprised in the agentic AI system. In accordance with this aspect, the method of flowchart 200 further includes one or more of the steps shown in flowchart 300 of FIG. 3. As shown in FIG. 3, the method of flowchart 300 begins at step 302. In step 302, a description of the invocation path is received from the controller AI sub-agent. In an example implementation, the completeness evaluation logic 734 receives an invocation path description 750 from the controller AI sub-agent. The invocation path description 750 describes the invocation path.

At step 304, a second evaluation of a completeness of the description of the invocation path, which is received from the controller AI sub-agent, is performed. The completeness of the description may be based on (e.g., based at least on) any of a variety of factors, including but not limited to whether the description includes (and/or a thoroughness of) an explanation (e.g., reasoning) as to why each of the AI sub-agents was chosen, a description of the outputs that are received from the AI sub-agents in response to the inputs to the AI sub-agents, and indication of tool(s) used by each of the AI sub-agents, and explanation as to why an AI sub-agent uses a particular tool, an explanation of a meaning of the output of each of the AI sub-agents, and a description of consequences of the outputs of the AI sub-agents. In an example implementation, the completeness evaluation logic 734 performs a second evaluation of a completeness of the invocation path description 750. The completeness evaluation logic 734 generates a completeness indicator 754, which indicates the completeness of the invocation path description 750 (i.e., the completeness of the description of the invocation path).

At step 306, a completeness score is assigned to the controller AI sub-agent as a result of the second evaluation. The completeness score corresponds to the completeness of the description of the invocation path. In an example implementation, the completeness action logic 736 assigns a completeness score 766 to the controller AI sub-agent as a result of the second evaluation of the completeness of the invocation path description 750. The completeness score 766 corresponds to the completeness of the invocation path description 750, as indicated by the completeness indicator 754.

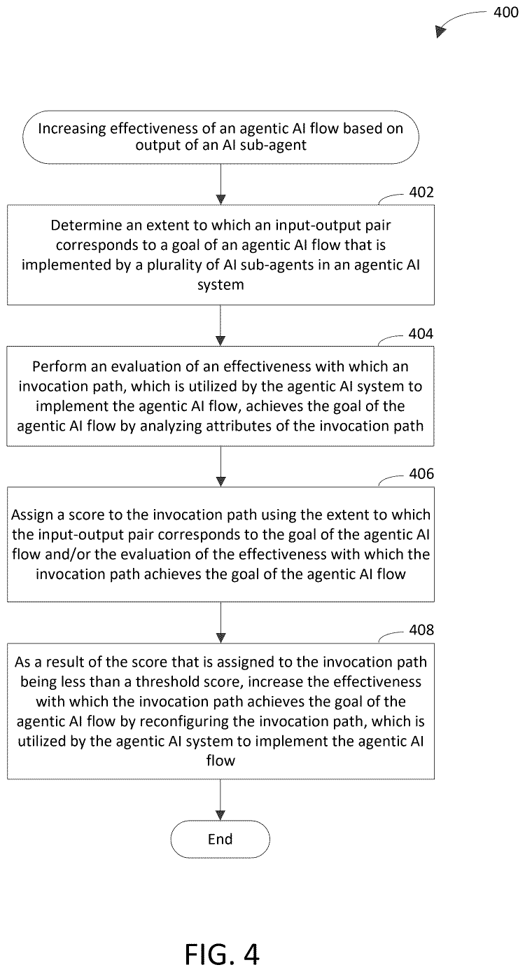

As shown in FIG. 4, the method of flowchart 400 begins at step 402. In step 402, an extent to which an input-output pair corresponds to a goal of an agentic AI flow is determined. The agentic AI flow is implemented by a plurality of AI sub-agents in an agentic AI system. The input-output pair comprises an AI input that is provided as an input to the agentic AI system and an AI response that is received as an output of the agentic AI system in response to the AI input. In an example implementation, the goal correspondence logic 722 determines an extent to which an input-output pair 738 corresponds to a goal of an agentic AI flow that is implemented by a plurality of AI sub-agents in an agentic AI system. In an aspect, goal information indicates (e.g., specifies or describes) the goal of the agentic AI flow. In accordance with this aspect, the goal correspondence logic 722 analyzes goal information 742 to determine (e.g., identify) the goal of the agentic AI flow. The input-output pair 738 comprises an AI input that is provided as an input to the agentic AI system and an AI response that is received as an output of the agentic AI system in response to the AI input. The goal correspondence logic 722 generates first extent information 758, which indicates the extent to which the input-output pair 738 corresponds to the goal of the agentic AI flow.

At step 404, an evaluation of an effectiveness with which an invocation path achieves the goal of the agentic AI flow is performed. The invocation path is utilized by the agentic AI system to implement the agentic AI flow. The evaluation is performed by analyzing attributes of the invocation path. The attributes of the invocation path comprise operations performed by the AI sub-agents to complete sub-tasks in the agentic AI flow that the AI sub-agents are responsible for completing. The attributes of the invocation path further comprise tools utilized by the AI sub-agents to perform at least a subset of the operations. In an example implementation, the effectiveness evaluation logic 726 performs the evaluation of the effectiveness with which the invocation path achieves the goal of the agentic AI flow by analyzing the attributes of the invocation path. The effectiveness evaluation logic 726 generates evaluation information 762, which indicates the effectiveness with which the invocation path achieves the goal of the agentic AI flow.

In an example embodiment, the attributes of the invocation path further comprise an order of the operations performed by the AI sub-agents to complete the sub-tasks in the agentic AI flow that the AI sub-agents are responsible for completing.

At step 406, a score is assigned to the invocation path using the extent to which the input-output pair corresponds to the goal of the agentic AI flow and/or the evaluation of the effectiveness with which the invocation path achieves the goal of the agentic AI flow. In an example implementation, the score assignment logic 728 assigns the score to the invocation path using the extent to which the input-output pair corresponds to the goal of the agentic AI flow and/or the evaluation of the effectiveness with which the invocation path achieves the goal of the agentic AI flow. In an aspect, the score assignment logic 728 analyzes the first extent information 758 to determine the extent to which the input-output pair 738 corresponds to the goal of the agentic AI flow. In another aspect, the score assignment logic 728 analyzes the evaluation information 762 to determine the effectiveness with which the invocation path achieves the goal of the agentic AI flow. The score assignment logic 728 generates score information 752 to indicate the score that is assigned to the invocation path.

At step 408, as a result of the score that is assigned to the invocation path being less than a threshold score, the effectiveness with which the invocation path achieves the goal of the agentic AI flow is increased by reconfiguring the invocation path. In an aspect, the score is in a range between zero and one. In accordance with this aspect, the threshold score may be 0.8 (e.g., 80%), 0.9 (e.g., 90%), or 0.95 (e.g., 95%). In another aspect, reconfiguring the invocation path comprises modifying one or more operations that are included in the invocation path, adding one or more operations to the invocation path, changing an order in which the operations of the invocation path are performed, adding an AI sub-agent (e.g., and corresponding functionality) to the plurality of AI sub-agents in the agentic AI system, reconfiguring one or more of the AI sub-agents (e.g., AI algorithm(s) that define the AI sub-agent(s)), changing which of the AI sub-agents performs a particular operation in the invocation path, changing a tool that is used by an AI sub-agent to perform a particular operation, and/or changing an order in which the AI sub-agents and/or tools of the AI sub-agents are used. In an example implementation, as a result of the score that is assigned to the invocation path being less than the threshold score 756, the reconfiguration logic 730 increases the effectiveness with which the invocation path achieves the goal of the agentic AI flow by performing a reconfiguration operation 764. The reconfiguration operation 764 comprises reconfiguring the invocation path.

In an example embodiment, an AI algorithm that defines a first AI sub-agent is configured to utilize an identified tool to perform a designated operation to complete a designated sub-task in the agentic AI flow. The first AI sub-agent is responsible for completing the designated sub-task. The AI sub-agents comprise the first sub-agent. In accordance with this embodiment, reconfiguring the invocation path at step 408 comprises reconfiguring the AI algorithm to utilize a designated tool, in lieu of the identified tool, to perform the designated operation to complete the designated sub-task in the agentic AI flow that the first AI sub-agent is responsible for completing.

In another example embodiment, reconfiguring the invocation path at step 408 comprises replacing an identified AI sub-agent with a replacement AI sub-agent. The AI sub-agents comprise the identified AI sub-agent.

In yet another example embodiment, performing the evaluation of the effectiveness with which the invocation path achieves the goal of the agentic AI flow at step 404 comprises determining that identified operations, which are comprised in the operations performed by the AI sub-agents, cause the invocation path to comprise an iterative loop. In accordance with this embodiment, reconfiguring the invocation path at step 408 comprises removing the iterative loop from the invocation path by reconfiguring an AI algorithm that defines a first AI sub-agent that performs at least a subset of the identified operations.

In an example embodiment, any one or more (e.g., all) of steps 402, 404, 406, and/or 408 are performed in real-time as the agentic AI flow is being implemented by the plurality of AI sub-agents in the agentic AI system (i.e., as the task is being performed by the agentic AI system). For instance, performing any one or more of the steps 402, 404, 406, and/or 408 in real-time may result in the effectiveness with which the invocation path achieves the goal of the agentic AI flow being increased to a greater extent, as compared to a scenario in which the steps 402, 404, 406, and 408 are performed after implementation of the agentic AI flow is completed.

In another example embodiment, steps 402, 404, 406, and 408 are performed after implementation of the agentic AI flow is completed (i.e., after performance of the task by the agentic AI system is completed). For instance, performing steps 402, 404, 406, and 408 after implementation of the agentic AI flow is completed may result in the agentic AI flow being implemented more quickly or at a lower cost than a scenario in which one or more of the steps 402, 404, 406, and/or 408 are performed in real-time.

In some example embodiments, one or more steps 402, 404, 406, and/or 408 of flowchart 400 may not be performed. Moreover, steps in addition to or in lieu of steps 402, 404, 406, and/or 408 may be performed. For instance, in an example embodiment, the method of flowchart 400 further includes determining extents to which intermediate input-output pairs of the AI sub-agents correspond to the sub-tasks in the agentic AI flow that the AI sub-agents are responsible for completing. The intermediate input-output pairs comprise inputs to the AI sub-agents and outputs that are received from the AI sub-agents in response to the inputs. In an example implementation, the sub-task correspondence logic 724 determines extents to which intermediate input-output pairs 742 of the AI sub-agents correspond to the sub-tasks in the agentic AI flow that the AI sub-agents are responsible for completing. The intermediate input-output pairs 742 comprise the inputs to the AI sub-agents and the outputs that are received from the AI sub-agents in response to the inputs. The sub-task correspondence logic 724 analyzes sub-task information 744 to determine the sub-tasks that the AI sub-agents are responsible for completing. For instance, the sub-task information 744 may cross-reference the AI sub-agents with the respective sub-tasks that the AI sub-agents are responsible for completing. In an aspect, the sub-task correspondence logic 724 compares the intermediate input-output pair for each AI sub-agent with the respective sub-task for the AI sub-agent, as indicated by the sub-task information 744, to determine the extents to which intermediate input-output pairs 742 of the AI sub-agents correspond to the sub-tasks that the AI sub-agents are responsible for completing. In accordance with this embodiment, the score is assigned to the invocation path at step 406 using a plurality of factors. The plurality of factors include the extent to which the input-output pair corresponds to the goal of the agentic AI flow, the evaluation of the effectiveness with which the invocation path achieves the goal of the agentic AI flow, and/or the extents to which the intermediate input-output pairs of the AI sub-agents correspond to the sub-tasks in the agentic AI flow that the AI sub-agents are responsible for completing. In an example implementation, the score assignment logic 728 assigns the score to the invocation path using the first extent information 758, the second extent information 760, and/or the evaluation information 762.

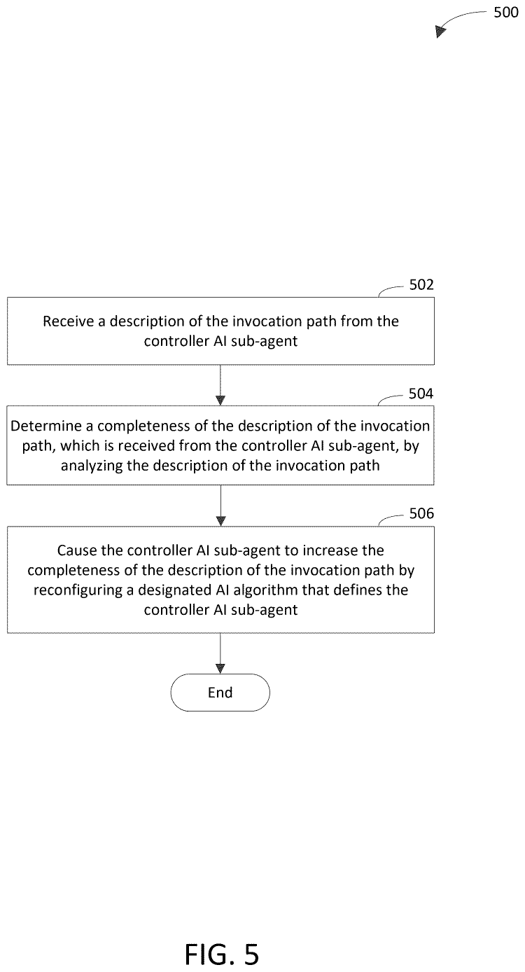

In another example embodiment, the invocation path is established by a controller AI sub-agent that coordinates execution of the AI sub-agents and that is comprised in the agentic AI system. In accordance with this embodiment, the method of flowchart 400 further includes one or more of the steps shown in flowchart 500 of FIG. 5. As shown in FIG. 5, the method of flowchart 500 begins at step 502. In step 502, a description of the invocation path is received from the controller AI sub-agent. In an example implementation, the completeness evaluation logic 734 receives an invocation path description 750 from the controller AI sub-agent. The invocation path description 750 describes the invocation path.

At step 504, a completeness of the description of the invocation path, which is received from the controller AI sub-agent, is determined. The completeness is determined by analyzing the description of the invocation path. In an example implementation, the completeness evaluation logic 734 determines a completeness of the invocation path description 750 (i.e., the description of the invocation path) by analyzing the invocation path description 750. The completeness evaluation logic 734 generates a completeness indicator 754, which indicates the completeness of the invocation path description 750.

At step 506, the controller AI sub-agent is caused to increase the completeness of the description of the invocation path by reconfiguring a designated AI algorithm that defines the controller AI sub-agent. In an aspect, the controller AI sub-agent is caused to increase the completeness of the description of the invocation path as a result of the completeness of the description of the invocation path being less than or equal to a threshold completeness. In an example of this aspect, the completeness of the description is represented by a number in a range between zero and one. In accordance with this example, the threshold completeness may be 0.8 (e.g., 80%), 0.9 (e.g., 90%), or 0.95 (e.g., 95%). In an example implementation, the completeness action logic 736 generates a completeness instruction 768, which causes the controller AI sub-agent to increase the completeness of the invocation path description 750 by reconfiguring the designated AI algorithm that defines the controller AI sub-agent. In an aspect, the completeness action logic 736 compares the completeness of the invocation path description 750, as indicated by the completeness indicator 754, and the completeness threshold to determine whether the completeness of the invocation path description 750 is less than or equal to the completeness threshold. In accordance with this aspect, the completeness action logic 736 generates the completeness instruction 768 as a result of the completeness of the invocation path description 750 being less than or equal to the completeness threshold.

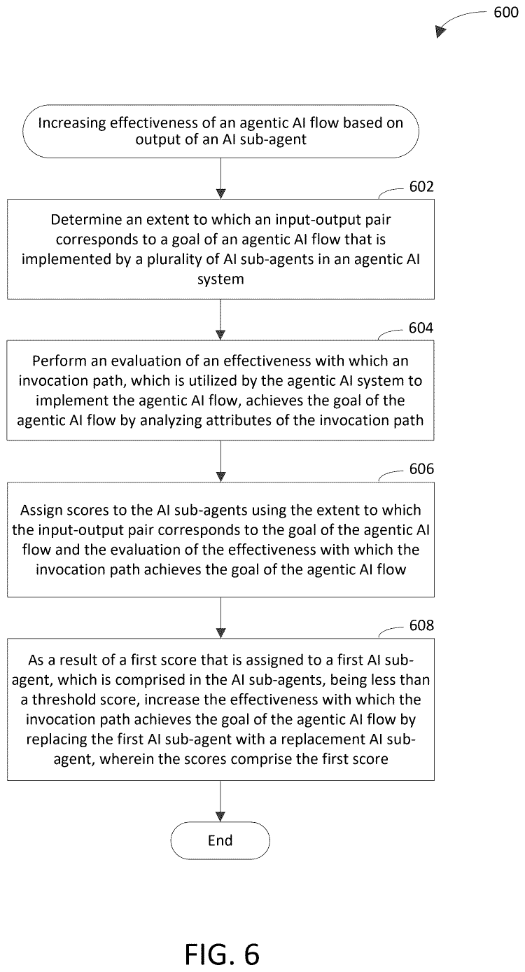

As shown in FIG. 6, the method of flowchart 600 begins at step 602. In step 602, an extent to which an input-output pair corresponds to a goal of an agentic AI flow is determined. The agentic AI flow is implemented by a plurality of AI sub-agents in an agentic AI system. The input-output pair comprises an AI input that is provided as an input to the agentic AI system and an AI response that is received as an output of the agentic AI system in response to the AI input. In an example implementation, the goal correspondence logic 722 determines an extent to which an input-output pair 738 corresponds to the goal of the agentic AI flow that is implemented by the plurality of AI sub-agents in the agentic AI system. The input-output pair 738 comprises the AI input that is provided as the input to the agentic AI system and the AI response that is received as the output of the agentic AI system in response to the AI input. The goal correspondence logic 722 analyzes goal information to determine the goal of the agentic AI flow. The goal correspondence logic 722 generates first extent information 758, which indicates the extent to which the input-output pair 738 corresponds to the goal of the agentic AI flow.

At step 604, an evaluation of an effectiveness with which an invocation path achieves the goal of the agentic AI flow is performed. The invocation path is utilized by the agentic AI system to implement the agentic AI flow. The evaluation is performed by analyzing attributes of the invocation path. The attributes of the invocation path comprise operations performed by the AI sub-agents to complete sub-tasks in the agentic AI flow that the AI sub-agents are responsible for completing and tools utilized by the AI sub-agents to perform at least a subset of the operations. In an example implementation, the effectiveness evaluation logic 726 performs the evaluation of the effectiveness with which the invocation path achieves the goal of the agentic AI flow by analyzing the attributes of the invocation path. The effectiveness evaluation logic 726 analyzes invocation path information 746 to determine the attributes of the invocation path. The effectiveness evaluation logic 726 analyzes the goal information 740 to determine the goal of the agentic AI flow. The effectiveness evaluation logic 726 generates evaluation information 762, which indicates the effectiveness with which the invocation path achieves the goal of the agentic AI flow.

In an example embodiment, the attributes of the invocation path further comprise an order of the operations performed by the AI sub-agents to complete the sub-tasks in the agentic AI flow that the AI sub-agents are responsible for completing.

In another example embodiment, performing the evaluation of the effectiveness with which the invocation path achieves the goal of the agentic AI flow at step 604 comprises determining whether identified operations cause the invocation path to comprise an iterative loop. The operations performed by the AI sub-agents comprise the identified operations.

At step 606, scores are assigned to the AI sub-agents using the extent to which the input-output pair corresponds to the goal of the agentic AI flow and the evaluation of the effectiveness with which the invocation path achieves the goal of the agentic AI flow. In an example implementation, the score assignment logic assigns the scores to the AI sub-agents using the extent to which the input-output pair 738 corresponds to the goal of the agentic AI flow and the evaluation of the effectiveness with which the invocation path achieves the goal of the agentic AI flow. In an aspect, the score assignment logic 728 analyzes the first extent information 758 to determine the extent to which the input-output pair 738 corresponds to the goal of the agentic AI flow. In another aspect, the score assignment logic 728 analyzes the evaluation information 762 to determine the effectiveness with which the invocation path achieves the goal of the agentic AI flow. The score assignment logic 728 generates score information 752, which indicates the scores that are assigned to the AI sub-agents. In an aspect, the score information 752 indicates which of the scores are assigned to which of the AI sub-agents.

At step 608, as a result of a first score that is assigned to a first AI sub-agent being less than a threshold score, the effectiveness with which the invocation path achieves the goal of the agentic AI flow is increased. The effectiveness is increased by replacing the first AI sub-agent with a replacement AI sub-agent. The AI sub-agents comprise the first AI sub-agent. The scores comprise the first score. In an aspect, the first score is in a range between zero and one. In accordance with this aspect, the threshold score may be 0.8 (e.g., 80%), 0.9 (e.g., 90%), or 0.95 (e.g., 95%). In an example implementation, as a result of the first score that is assigned to the first AI sub-agent being less than the threshold score 756, the reconfiguration logic 730 increases the effectiveness with which the invocation path achieves the goal of the agentic AI flow by replacing the first AI sub-agent with the replacement AI sub-agent. In an aspect, the reconfiguration logic 730 analyzes the score information 752 to determine the first score that is assigned to the first AI sub-agent.

In an example embodiment, the first AI sub-agent is configured to utilize an identified tool to perform a designated operation to complete a designated sub-task in the agentic AI flow. In accordance with this embodiment, replacing the first AI sub-agent with the replacement sub-agent at step 608 comprises configuring the replacement AI sub-agent to utilize the identified tool to perform the designated operation to complete the designated sub-task. The replacement AI sub-agent is responsible for completing the designated sub-task.

In another example embodiment, the first AI sub-agent is configured to utilize an identified tool to perform a designated operation to complete a designated sub-task in the agentic AI flow. In accordance with this embodiment, replacing the first AI sub-agent with the replacement sub-agent at step 608 comprises configuring the replacement AI sub-agent to utilize a designated tool, in lieu of the identified tool, to perform the designated operation to complete the designated sub-task. The replacement AI sub-agent is responsible for completing the designated sub-task.

In some example embodiments, one or more steps 602, 604, 606, and/or 608 of flowchart 600 may not be performed. Moreover, steps in addition to or in lieu of steps 602, 604, 606, and/or 608 may be performed. For instance, in an example embodiment, the invocation path is established by a controller AI sub-agent that coordinates execution of the AI sub-agents and that is comprised in the agentic AI system. In accordance with this embodiment, the method of flowchart 600 includes any one or more of the steps shown in flowchart 300 of FIG. 3, which is described in further detail above.

In an aspect of this embodiment, the method of flowchart 600 further includes, as a result of the completeness score being less than a threshold completeness score, configuring a designated AI algorithm that defines the controller AI sub-agent to generate a replacement description of the invocation path having a corresponding completeness. The corresponding completeness corresponds to a corresponding completeness score that is greater than or equal to the threshold completeness score. For instance, the threshold completeness score may be 80%, 90%, or 95%. In an example implementation, as a result of the completeness score 766 being less than a threshold completeness score 748, the reconfiguration logic 730 configures the designated AI algorithm that defines the controller AI sub-agent to generate the replacement description of the invocation path having the corresponding completeness. The corresponding completeness corresponds to the corresponding completeness score, which is greater than or equal to the threshold completeness score 748. In an aspect, the reconfiguration logic 730 compares the completeness score 766 and the threshold completeness score 748 to determine that the completeness score 766 is less than the threshold completeness score 748.

In an example embodiment, any one or more (e.g., all) of steps 602, 604, 606, and/or 608 are performed in real-time as the agentic AI flow is being implemented by the plurality of AI sub-agents in the agentic AI system (i.e., as the task is being performed by the agentic AI system). For instance, performing any one or more of the steps 602, 604, 606, and/or 608 in real-time may result in the effectiveness with which the invocation path achieves the goal of the agentic AI flow being increased to a greater extent, as compared to a scenario in which the steps 602, 604, 606, and 608 are performed after implementation of the agentic AI flow is completed.

In another example embodiment, steps 602, 604, 606, and 608 are performed after implementation of the agentic AI flow is completed (i.e., after performance of the task by the agentic AI system is completed). For instance, performing steps 602, 604, 606, and 608 after implementation of the agentic AI flow is completed may result in the agentic AI flow being implemented more quickly or at a lower cost than a scenario in which one or more of the steps 602, 604, 606, and/or 608 are performed in real-time.

Any one or more of the steps described herein may be performed by an AI model.

Any one or more of the operations described herein may be performed using an AI system. In an example embodiment, the goal correspondence logic 722 causes (e.g., triggers) the AI system to analyze (e.g., develop and/or refine an understanding of) a first AI input, first contextual information (including the input-output pair 738 and the goal information 740), relationships between any of the foregoing, and confidences in those relationships. The first AI input requests a determination of an extent to which the input-output pair 738 corresponds to a goal of an agentic AI flow, which is indicated by the goal information 740. In an aspect, the goal correspondence logic 722 causes the AI system to compare attributes of the first AI input and the first contextual information (including the input-output pair 738 and the goal information 740) using artificial intelligence to generate the first extent information 758. The first contextual information may further include sample AI input(s) and sample contextual information (e.g., sample input-output pair(s) and sample goal information).

In another example embodiment, the sub-task correspondence logic 724 causes (e.g., triggers) the AI system to analyze (e.g., develop and/or refine an understanding of) a second AI input, second contextual information (including the intermediate input-output pairs 742 and the sub-task information 744), relationships between any of the foregoing, and confidences in those relationships. The second AI input requests a determination of extents to which the intermediate input-output pairs 742 of the AI sub-agents correspond to sub-tasks in the agentic AI flow that the AI sub-agents are responsible for performing. The sub-tasks are indicated by the sub-task information 744. In an aspect, the sub-task correspondence logic 724 causes the AI system to compare attributes of the second AI input and the second contextual information (including the intermediate input-output pairs 742 and the sub-task information 744) using artificial intelligence to generate the second extent information 760. The second contextual information may further include sample AI input(s) and sample contextual information (e.g., sample intermediate input-output pairs and sample sub-task information).

In yet another example embodiment, the effectiveness evaluation logic 726 causes (e.g., triggers) the AI system to analyze (e.g., develop and/or refine an understanding of) a third AI input, third contextual information (including the invocation path information 746 and the goal information 740), relationships between any of the foregoing, and confidences in those relationships. The third AI input requests evaluation of an effectiveness with which an invocation path, which is utilized by the agentic AI system to implement the agentic AI flow, achieves the goal of the agentic AI flow by taking into consideration attributes of the invocation path indicated by the invocation path information 746 and the goal of the agentic AI flow indicated by the goal information 740. In an aspect, the effectiveness evaluation logic 726 causes the AI system to compare attributes of the third AI input and the third contextual information (including the invocation path information 746 and the goal information 740) using artificial intelligence to generate the evaluation information 762. The third contextual information may further include sample AI input(s) and sample contextual information (e.g., sample invocation path information and sample goal information).

In still another example embodiment, the score assignment logic 728 causes (e.g., triggers) the AI system to analyze (e.g., develop and/or refine an understanding of) a fourth AI input, fourth contextual information (including the first extent information 758, the second extent information 760, and/or the evaluation information 762), relationships between any of the foregoing, and confidences in those relationships. In an aspect, the fourth AI input requests assignment of scores to the AI sub-agents using the extent to which the input-output pair corresponds to the goal of the agentic AI flow as indicated by the first extent information 758, the extents to which the intermediate input-output pairs of the AI sub-agents correspond to the sub-tasks that the AI sub-agents are responsible for performing as indicated by the second event information 760, and/or the effectiveness with which the invocation path achieves the goal of the agentic AI flow as indicated by the evaluation information 762. In another aspect, the fourth AI input requests assignment of a score to the invocation path using the extent to which the input-output pair corresponds to the goal of the agentic AI flow as indicated by the first extent information 758, the extents to which the intermediate input-output pairs of the AI sub-agents correspond to the sub-tasks that the AI sub-agents are responsible for performing as indicated by the second event information 760, and/or the effectiveness with which the invocation path achieves the goal of the agentic AI flow as indicated by the evaluation information 762. In yet another aspect, the score assignment logic 728 causes the AI system to compare attributes of the fourth AI input and the fourth contextual information (including the first extent information 758, the second extent information 760, and/or the evaluation information 762) using artificial intelligence to generate the score information 752. The fourth contextual information may further include sample AI input(s) and sample contextual information (e.g., sample first extent information, sample second extent information, and/or sample evaluation information).

In another example embodiment, the explanation analysis logic 732 causes (e.g., triggers) the AI system to analyze (e.g., develop and/or refine an understanding of) a fifth AI input, fifth contextual information (including the invocation path description 750), relationships between any of the foregoing, and confidences in those relationships. In an aspect, the fifth AI input requests assignment of the completeness score 766 to the controller AI sub-agent to indicate the completeness of the invocation path description 750. In another aspect, the fifth AI input requests generation of the completeness instruction 768, which causes the controller AI sub-agent to increase the completeness of the invocation path description 750 by reconfiguring the designated AI algorithm that defines the controller AI sub-agent. In yet an aspect, the explanation analysis logic 732 causes the AI system to compare attributes of the fifth AI input and the fifth contextual information (including the invocation path description 750) using artificial intelligence to generate the completeness score 766 and/or the completeness instruction 768. The fifth contextual information may further include sample AI input(s) and sample contextual information (e.g., sample invocation path description(s)).

In some example embodiments, the AI system includes a neural network that uses the artificial intelligence to determine (e.g., predict) relationships between any of the AI inputs described herein and any of the corresponding contextual information and confidences in the relationships. The neural network uses those relationships to generate the corresponding AI responses. For example, attributes of the AI input, the contextual information, and potentially example AI input(s) and example AI response(s) to the AI input(s) may be compared to determine similarities and differences between those attributes. In accordance with this example, the neural network may use those similarities and differences to generate the corresponding AI responses.

Examples of a neural network include but are not limited to a feed forward neural network and a transformer-based neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the goal correspondence logic 722, the sub-task correspondence logic 724, the effectiveness evaluation logic 726, the score assignment logic 728, and/or the explanation analysis logic 732 employs a feed forward neural network to train the AI system (e.g., at least one AI model therein), which is used to determine AI-based confidences. Such AI-based confidences may be used to determine likelihoods that events will occur.

A transformer-based neural network is a neural network that incorporates a transformer. A transformer is a deep learning model that utilizes attention to differentially weight the significance of each portion of sequential input data, such as natural language. Attention is a technique that mimics cognitive attention. Cognitive attention is a behavioral and cognitive process of selectively concentrating on a discrete aspect of information while ignoring other perceivable aspects of the information. Accordingly, the transformer uses the attention to enhance some portions of the input data while diminishing other portions. The transformer determines which portions of the input data to enhance and which portions of the input data to diminish based on the context of each portion. For instance, the transformer may be trained to identify the context of each portion using any suitable technique, such as gradient descent.

In an example embodiment, the transformer-based neural network generates an effectiveness enhancement model (e.g., to increase effectiveness of an agentic AI flow based on output of an AI sub-agent) by utilizing information, such as AI inputs, contextual information, relationships between any of the foregoing, and AI-based confidences that are derived therefrom.

In example embodiments, the goal correspondence logic 722, the sub-task correspondence logic 724, the effectiveness evaluation logic 726, the score assignment logic 728, and/or the explanation analysis logic 732 includes training logic, and the AI system includes inference logic. The training logic is configured to train an AI algorithm that the inference logic uses to determine (e.g., infer) the AI-based confidences. For instance, the training logic may provide sample AI inputs and sample contextual information as inputs to the AI algorithm to train the AI algorithm. The sample data may be labeled. The AI algorithm may be configured to derive relationships between the features (e.g., the AI input and the contextual information) and the resulting AI-based confidences. The inference logic is configured to utilize the AI algorithm, which is trained by the training logic, to determine the AI-based confidence when the features are provided as inputs to the algorithm.

In an example embodiment, the AI system includes (e.g., is) a generative language model. A generative language model is an AI model that is capable of generating original text output based on sample data. Examples of a generative language model include but are not limited to a generative pre-trained transformer 3 (GPT-3®) model and a generative pre-trained transformer 4 (GPT-4®) model, developed and distributed by OpenAI, Inc.; a Phi™ model and a Turing-NLG™ model, developed and distributed by Microsoft Corporation; a large language model Meta AI (LLaMA®) model, developed and distributed by Meta Platforms Inc. ; a language model for dialogue applications (LaMDA®) model and a Gemini® model, developed and distributed by Google LLC; and a BigScience large open-science open-access multilingual language model (BLOOM) model, developed and distributed by the BigScience collaborative initiative. A generative language model may use any suitable relevancy determination and/or ranking technique. For instance, the generative language model may use a BM25 (Okapi BM25) ranking function to perform its analysis (e.g., based on keywords).

In another example embodiment, the AI system includes a large language model (LLM). A large language model is an artificial neural network that is capable of performing natural language processing (NLP) tasks. For instance, the large language model may use a transformer model to perform the NLP tasks. In an aspect, the large language model is trained (e.g., pre-trained) using self-supervised learning and semi-supervised learning. Examples of a large language model include but are not limited to the GPT-3® and GPT-4® models, developed and distributed by OpenAI, Inc.; the LLaMA® model, developed and distributed by Meta Platforms Inc.; and a pathways language model (PaLM®) model and the Gemini® model, developed and distributed by Google LLC.

In yet another example embodiment, the AI system includes an embedding model. An embedding model is an AI model that uses deep learning to convert data into vectors, which represent attributes of the data, and that compares at least a subset of the vectors to determine an extent to which the vectors that are included in the subset are similar. For instance, each vector may represent a semantic meaning of one or more AI inputs, one or more instances of contextual information, and/or one or more AI responses. In an aspect of this embodiment, the AI system (e.g., at least one AI model therein) generates an AI response to an AI input described herein using an embedding model. In an example of this aspect, the embedding model is an encoder-only model. One example of an encoder-only model is the bidirectional encoder representations from transformers (BERT™) model, which is developed and distributed by Google LLC. In another example of this aspect, the embedding model is a decoder-only model. In yet another example of this aspect, the embedding model is an encoder-decoder model. One example of an encoder-decoder model is the FLAN-T5™ model, which is developed and distributed by Google LLC.

In still another example embodiment, the AI system includes multiple types of AI models. Weights may be applied to the responses generated by the respective types of AI models. For example, the AI system may include a generative AI model and an embedding model. In accordance with this example, a first weight may be applied to a first response generated by the generative AI model to provide a first weighted response, and a second weight that is different from the first weight may be applied to a second response of the embedding model to provide a second weighted response. The AI system may combine (e.g., sum) the first weighted response and the second weighted response to generate a response of the AI system.

It will be recognized that the computing system 700 may not include one or more of the AI sub-agent output-based effectiveness logic 708, the store 720, the goal correspondence logic 722, the sub-task correspondence logic 724, the effectiveness evaluation logic 726, the score assignment logic 728, the reconfiguration logic 730, the explanation analysis logic 732, the completeness evaluation logic 734, and/or the completeness action logic 736. Furthermore, the computing system 700 may include components in addition to or in lieu of the AI sub-agent output-based effectiveness logic 708, the store 720, the goal correspondence logic 722, the sub-task correspondence logic 724, the effectiveness evaluation logic 726, the score assignment logic 728, the reconfiguration logic 730, the explanation analysis logic 732, the completeness evaluation logic 734, and/or the completeness action logic 736.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the AI sub-agent output-based effectiveness logic 108, the agentic AI system 110, one or more of the AI sub-agents 112A-112P, the AI sub-agent output-based effectiveness logic 708, the goal correspondence logic 722, the sub-task correspondence logic 724, the effectiveness evaluation logic 726, the score assignment logic 728, the reconfiguration logic 730, the explanation analysis logic 732, the completeness evaluation logic 734, the completeness action logic 736, flowchart 200, flowchart 300, flowchart 400, flowchart 500, and/or flowchart 600 may be implemented in hardware, software, firmware, or any combination thereof.

For example, any one or more of the AI sub-agent output-based effectiveness logic 108, the agentic AI system 110, one or more of the AI sub-agents 112A-112P, the AI sub-agent output-based effectiveness logic 708, the goal correspondence logic 722, the sub-task correspondence logic 724, the effectiveness evaluation logic 726, the score assignment logic 728, the reconfiguration logic 730, the explanation analysis logic 732, the completeness evaluation logic 734, the completeness action logic 736, flowchart 200, flowchart 300, flowchart 400, flowchart 500, and/or flowchart 600 may be implemented, at least in part, as computer program code configured to be executed in one or more processors.

In another example, any one or more of the AI sub-agent output-based effectiveness logic 108, the agentic AI system 110, one or more of the AI sub-agents 112A-112P, the AI sub-agent output-based effectiveness logic 708, the goal correspondence logic 722, the sub-task correspondence logic 724, the effectiveness evaluation logic 726, the score assignment logic 728, the reconfiguration logic 730, the explanation analysis logic 732, the completeness evaluation logic 734, the completeness action logic 736, flowchart 200, flowchart 300, flowchart 400, flowchart 500, and/or flowchart 600 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

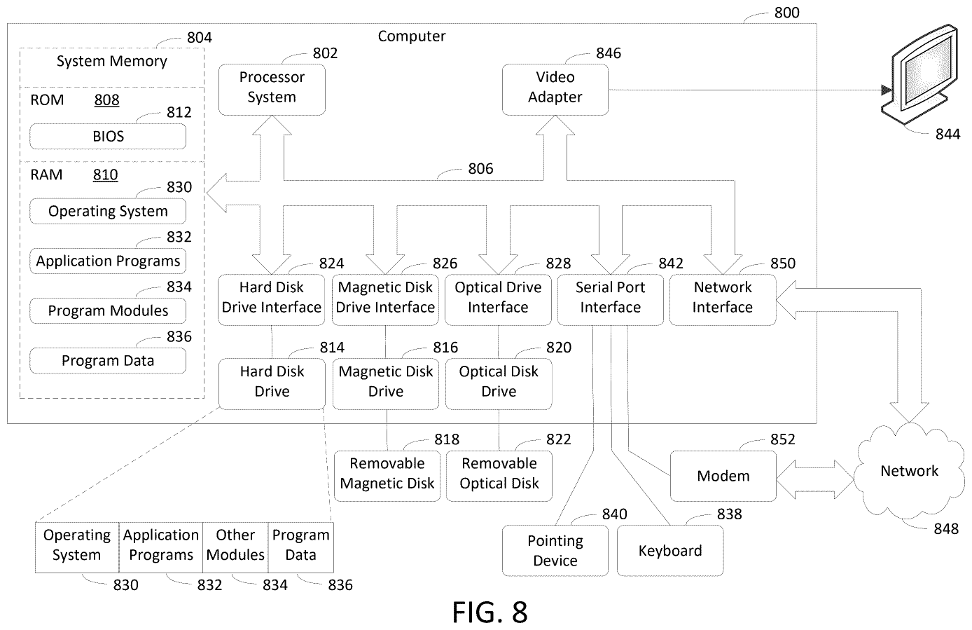

(A1) An example system (FIG. 1, 102A-102M, 106A-106N; FIGS. 7, 700; FIGS. 8, 800) comprises a processor system (FIGS. 8, 802) and a memory (FIGS. 8, 804, 808, 810) that stores computer-executable instructions. The computer-executable instructions are executable by the processor system to at least determine (FIGS. 2, 202) an extent to which an input-output pair (FIGS. 7, 738) corresponds to a goal of an agentic artificial intelligence (AI) flow that is implemented by a plurality of AI sub-agents in an agentic AI system. The input-output pair comprises an AI input that is provided as an input to the agentic AI system and an AI response that is received as an output of the agentic AI system in response to the AI input. The computer-executable instructions are executable by the processor system further to at least determine (FIGS. 2, 204) extents to which intermediate input-output pairs (FIGS. 7, 742) of the AI sub-agents correspond to sub-tasks in the agentic AI flow that the AI sub-agents are responsible for performing. The intermediate input-output pairs comprise inputs to the AI sub-agents and outputs that are received from the AI sub-agents in response to the inputs. The computer-executable instructions are executable by the processor system further to at least assign (FIGS. 2, 206) scores to the AI sub-agents using the extent to which the input-output pair corresponds to the goal of the agentic AI flow and the extents to which the intermediate input-output pairs of the AI sub-agents correspond to the sub-tasks that the AI sub-agents are responsible for performing. The computer-executable instructions are executable by the processor system further to at least, as a result of a first score that is assigned to a first AI sub-agent being less than a threshold score (FIGS. 7, 756), increase (FIGS. 2, 208) the extent to which the intermediate input-output pair of the first AI sub-agent corresponds to a first sub-task that the first AI sub-agent is configured to perform by reconfiguring an AI algorithm that defines the first AI sub-agent. The AI sub-agents comprise the first AI sub-agent. The scores comprise the first score.
(A2) In the example system of A1, wherein the extent to which the input-output pair corresponds to the goal of the agentic AI flow takes into consideration whether the AI response comprises an error.
(A3) In the example system of any of A1-A2, wherein the extent to which the input-output pair corresponds to the goal of the agentic AI flow takes into consideration a number of hallucinations that are comprised in the AI response.
(A4) In the example system of any of A1-A3, wherein the extent to which the input-output pair corresponds to the goal of the agentic AI flow takes into consideration a number of instances of required information that are omitted from the AI response, wherein the instances of the required information are instances of information that are required to achieve the goal of the agentic AI flow.
(A5) In the example system of any of A1-A4, wherein the computer-executable instructions are executable by the processor system to at least: determine clarity of the AI response by analyzing the AI response with reference to a clarity standard; and determine the extent to which the input-output pair corresponds to the goal of the agentic AI flow by taking into consideration the clarity of the AI response.
(A6) In the example system of any of A1-A5, wherein the computer-executable instructions are executable by the processor system to at least: determine usefulness of the AI response by analyzing the AI response with reference to a usefulness standard; and determine the extent to which the input-output pair corresponds to the goal of the agentic AI flow by taking into consideration the usefulness of the AI response.
(A7) In the example system of any of A1-A6, wherein an extent to which an intermediate input-output pair of an AI sub-agent corresponds to a sub-task in the agentic AI flow that the AI sub-agent is responsible for performing takes into consideration whether an output that is received from the AI sub-agent in response to an input to the AI sub-agent comprises an error.
(A8) In the example system of any of A1-A7, wherein an extent to which an intermediate input-output pair of an AI sub-agent corresponds to a sub-task in the agentic AI flow that the AI sub-agent is responsible for performing takes into consideration a number of hallucinations that are comprised in an output that is received from the AI sub-agent in response to an input to the AI sub-agent.
(A9) In the example system of any of A1-A8, wherein an extent to which an intermediate input-output pair of an AI sub-agent corresponds to a sub-task in the agentic AI flow that the AI sub-agent is responsible for performing takes into consideration a number of instances of required information that are omitted from an output that is received from the AI sub-agent in response to an input to the AI sub-agent, wherein the instances of the required information are instances of information that are required to complete a sub-task in the agentic AI flow that the AI sub-agent is responsible for performing.
(A10) In the example system of any of A1-A9, wherein the computer-executable instructions are executable by the processor system to at least: determine clarity of the outputs that are received from the AI sub-agents by analyzing the outputs that are received from the AI sub-agents with reference to a clarity standard; and determine the extents to which the intermediate input-output pairs of the AI sub-agents correspond to the sub-tasks in the agentic AI flow that the AI sub-agents are responsible for performing by taking into consideration the clarity of the outputs that are received from the AI sub-agents.
(A11) In the example system of any of A1-A10, wherein the computer-executable instructions are executable by the processor system to at least: determine usefulness of the outputs that are received from the AI sub-agents by analyzing the outputs that are received from the AI sub-agents with reference to a usefulness standard; and determine the extents to which the intermediate input-output pairs of the AI sub-agents correspond to the sub-tasks in the agentic AI flow that the AI sub-agents are responsible for performing by taking into consideration the usefulness of the outputs that are received from the AI sub-agents.
(A12) In the example system of any of A1-A11, wherein the computer-executable instructions are executable by the processor system to at least: perform an evaluation of an effectiveness with which an invocation path, which is utilized by the agentic AI system to implement the agentic AI flow, achieves the goal of the agentic AI flow by analyzing attributes of the invocation path, the attributes of the invocation path comprising operations performed by the AI sub-agents to execute sub-tasks in the agentic AI flow that the AI sub-agents are responsible for executing and tools utilized by the AI sub-agents to perform at least a subset of the operations; and assign the scores to the AI sub-agents using the extent to which the input-output pair corresponds to the goal of the agentic AI flow, the extents to which the intermediate input-output pairs of the AI sub-agents correspond to the sub-tasks that the AI sub-agents are responsible for performing, and the evaluation of the effectiveness with which the invocation path achieves the goal of the agentic AI flow.
(A13) In the example system of any of A1-A12, wherein the attributes of the invocation path further comprise an order of the operations performed by the AI sub-agents to execute the sub-tasks in the agentic AI flow that the AI sub-agents are responsible for executing.
(A14) In the example system of any of A1-A13, wherein the computer-executable instructions are executable by the processor system to perform the evaluation of the effectiveness with which the invocation path achieves the goal of the agentic AI flow by determining whether identified operations, which are comprised in the operations performed by the AI sub-agents, cause the invocation path to comprise an iterative loop.
(A15) In the example system of any of A1-A14, wherein the computer-executable instructions are executable by the processor system to at least: perform the evaluation of the effectiveness with which the invocation path, which is established by a controller AI sub-agent that coordinates execution of the AI sub-agents and that is comprised in the agentic AI system, achieves the goal of the agentic AI flow; receive a description of the invocation path from the controller AI sub-agent; perform a second evaluation of a completeness of the description of the invocation path, which is received from the controller AI sub-agent; and assign a completeness score to the controller AI sub-agent as a result of the second evaluation, the completeness score corresponding to the completeness of the description of the invocation path.
(B1) An example method is implemented by a computing system (FIG. 1, 102A-102M, 106A-106N; FIGS. 7, 700; FIGS. 8, 800). The method comprises performing (FIGS. 4, 404) an evaluation of an effectiveness with which an invocation path, which is utilized by a plurality of artificial intelligence (AI) sub-agents in an agentic AI system to implement an agentic AI flow, achieves a goal of the agentic AI flow by analyzing attributes of the invocation path. The attributes of the invocation path comprise operations performed by the AI sub-agents to complete sub-tasks in the agentic AI flow that the AI sub-agents are responsible for completing and tools utilized by the AI sub-agents to perform at least a subset of the operations. The method further comprises assigning (FIGS. 4, 406) a score to the invocation path using the evaluation of the effectiveness with which the invocation path achieves the goal of the agentic AI flow. The method further comprises, as a result of the score that is assigned to the invocation path being less than a threshold score, increasing (FIGS. 4, 408) the effectiveness with which the invocation path achieves the goal of the agentic AI flow by reconfiguring the invocation path, which is utilized by the plurality of AI sub-agents to implement the agentic AI flow.
(B2) In the example method of B1, wherein the attributes of the invocation path further comprise an order of the operations performed by the AI sub-agents to complete the sub-tasks in the agentic AI flow that the AI sub-agents are responsible for completing.
(B3) In the example method of any of B1-B2, wherein performing the evaluation of the effectiveness with which the invocation path achieves the goal of the agentic AI flow comprises: determining that identified operations, which are comprised in the operations performed by the AI sub-agents, cause the invocation path to comprise an iterative loop; and wherein reconfiguring the invocation path comprises: removing the iterative loop from the invocation path by reconfiguring an AI algorithm that defines a first AI sub-agent that performs at least a subset of the identified operations.
(B4) In the example method of any of B1-B3, wherein performing the evaluation of the effectiveness with which the invocation path achieves the goal of the agentic AI flow comprises: performing the evaluation of the effectiveness with which the invocation path, which is established by a controller AI sub-agent that coordinates execution of the AI sub-agents and that is comprised in the agentic AI system, achieves the goal of the agentic AI flow; and wherein the method further comprises: receiving a description of the invocation path from the controller AI sub-agent; determining a completeness of the description of the invocation path, which is received from the controller AI sub-agent, by analyzing the description of the invocation path; and causing the controller AI sub-agent to increase the completeness of the description of the invocation path by reconfiguring a designated AI algorithm that defines the controller AI sub-agent.
(B5) In the example method of any of B1-B4, wherein an AI algorithm that defines a first AI sub-agent, which is comprised in the AI sub-agents, is configured to utilize an identified tool to perform a designated operation to complete a designated sub-task in the agentic AI flow that the first AI sub-agent is responsible for completing; and wherein reconfiguring the invocation path comprises: reconfiguring the AI algorithm, which defines the first AI sub-agent, to utilize a designated tool, in lieu of the identified tool, to perform the designated operation to complete the designated sub-task in the agentic AI flow that the first AI sub-agent is responsible for completing.
(B6) In the example method of any of B1-B5, wherein reconfiguring the invocation path comprises: replacing an identified AI sub-agent, which is comprised in the AI sub-agents, with a replacement AI sub-agent.
(B7) In the example method of any of B1-B6, further comprising: determining extents to which intermediate input-output pairs of the AI sub-agents correspond to the sub-tasks in the agentic AI flow that the AI sub-agents are responsible for completing, the intermediate input-output pairs comprising inputs to the AI sub-agents and outputs that are received from the AI sub-agents in response to the inputs; wherein assigning the score to the invocation path comprises: assigning the score to the invocation path using the evaluation of the effectiveness with which the invocation path achieves the goal of the agentic AI flow and the extents to which the intermediate input-output pairs of the AI sub-agents correspond to the sub-tasks in the agentic AI flow that the AI sub-agents are responsible for completing.
(C1) An example computer program product (FIGS. 8, 818, 822) comprises a computer-readable storage medium having instructions recorded thereon for enabling a processor-based system (FIG. 1, 102A-102M, 106A-106N; FIGS. 7, 700; FIGS. 8, 800) to perform operations. The operations comprise determining (FIGS. 6, 602) an extent to which an input-output pair (FIGS. 7, 738) corresponds to a goal of an agentic artificial intelligence (AI) flow that is implemented by a plurality of AI sub-agents in an agentic AI system. The input-output pair comprises an AI input that is provided as an input to the agentic AI system and an AI response that is received as an output of the agentic AI system in response to the AI input. The operations further comprise performing (FIGS. 6, 604) an evaluation of an effectiveness with which an invocation path, which is utilized by the agentic AI system to implement the agentic AI flow, achieves the goal of the agentic AI flow by analyzing attributes of the invocation path. The attributes of the invocation path comprise operations performed by the AI sub-agents to complete sub-tasks in the agentic AI flow that the AI sub-agents are responsible for completing and tools utilized by the AI sub-agents to perform at least a subset of the operations. The operations further comprise assigning (FIGS. 6, 606) scores to the AI sub-agents using the extent to which the input-output pair corresponds to the goal of the agentic AI flow and the evaluation of the effectiveness with which the invocation path achieves the goal of the agentic AI flow. The operations further comprise, as a result of a first score that is assigned to a first AI sub-agent, which is comprised in the AI sub-agents, being less than a threshold score, increasing (FIGS. 6, 608) the effectiveness with which the invocation path achieves the goal of the agentic AI flow by replacing the first AI sub-agent with a replacement AI sub-agent. The scores comprise the first score.
(C2) In the example computer program product of C1, wherein the first AI sub-agent is configured to utilize an identified tool to perform a designated operation to complete a designated sub-task in the agentic AI flow; and wherein the operations comprise: configuring the replacement AI sub-agent to utilize the identified tool to perform the designated operation to complete the designated sub-task, which the replacement AI sub-agent is responsible for completing.
(C3) In the example computer program product of any of C1-C2, wherein the first AI sub-agent is configured to utilize an identified tool to perform a designated operation to complete a designated sub-task in the agentic AI flow; and wherein the operations comprise: configuring the replacement AI sub-agent to utilize a designated tool, in lieu of the identified tool, to perform the designated operation to complete the designated sub-task, which the replacement AI sub-agent is responsible for completing.
(C4) In the example computer program product of any of C1-C3, wherein the attributes of the invocation path further comprise an order of the operations performed by the AI sub-agents to complete the sub-tasks in the agentic AI flow that the AI sub-agents are responsible for completing.
(C5) In the example computer program product of any of C1-C4, wherein the operations comprise: performing the evaluation of the effectiveness with which the invocation path achieves the goal of the agentic AI flow by determining whether identified operations, which are comprised in the operations performed by the AI sub-agents, cause the invocation path to comprise an iterative loop.
(C6) In the example computer program product of any of C1-C5, wherein the operations comprise: performing the evaluation of the effectiveness with which the invocation path, which is established by a controller AI sub-agent that coordinates execution of the AI sub-agents and that is comprised in the agentic AI system, achieves the goal of the agentic AI flow; receiving a description of the invocation path from the controller AI sub-agent; performing a second evaluation of a completeness of the description of the invocation path, which is received from the controller AI sub-agent; and assigning a completeness score to the controller AI sub-agent as a result of the second evaluation, the completeness score corresponding to the completeness of the description of the invocation path.
(C7) In the example computer program product of any of C1-C6, wherein the operations further comprise: as a result of the completeness score being less than a threshold completeness score, configuring a designated AI algorithm that defines the controller AI sub-agent to generate a replacement description of the invocation path having a corresponding completeness, which corresponds to a corresponding completeness score that is greater than or equal to the threshold completeness score.

### III. Example Computer System

FIG. 8 depicts an example computer 800 in which embodiments may be implemented.

Any one or more of the user devices 102A-102M and/or any one or more of the servers 106A-106N shown in FIG. 1 and/or the computing system 700 shown in FIG. 7 may be implemented using computer 800, including one or more features of computer 800 and/or alternative features. Computer 800 may be a general-purpose computing device in the form of a conventional personal computer, a mobile computer, or a workstation, for example, or computer 800 may be a special purpose computing device. The description of computer 800 provided herein is provided for purposes of illustration, and is not intended to be limiting. Embodiments may be implemented in further types of computer systems, as would be known to persons skilled in the relevant art(s).

As shown in FIG. 8, computer 800 includes a processor system 802, a system memory 804, and a bus 806 that couples various system components including system memory 804 to processor system 802. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computer 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 830, one or more application programs 832, other program modules 834, and program data 836. Application programs 832 or program modules 834 may include, for example, computer program logic for implementing any one or more of (e.g., at least a portion of) the AI sub-agent output-based effectiveness logic 108, the agentic AI system 110, one or more of the AI sub-agents 112A-112P, the AI sub-agent output-based effectiveness logic 708, the goal correspondence logic 722, the sub-task correspondence logic 724, the effectiveness evaluation logic 726, the score assignment logic 728, the reconfiguration logic 730, the explanation analysis logic 732, the completeness evaluation logic 734, the completeness action logic 736, flowchart 200 (including any step of flowchart 200), flowchart 300 (including any step of flowchart 300), flowchart 400 (including any step of flowchart 400), flowchart 500 (including any step of flowchart 500), and/or flowchart 600 (including any step of flowchart 600), as described herein.

A user may enter commands and information into the computer 800 through input devices such as keyboard 838 and pointing device 840. Other input devices (not shown) may include a microphone, joystick, game pad, satellite dish, scanner, touch screen, camera, accelerometer, gyroscope, or the like. These and other input devices are often connected to the processor system 802 through a serial port interface 842 that is coupled to bus 806, but may be connected by other interfaces, such as a parallel port, game port, or a universal serial bus (USB).

A display device 844 (e.g., a monitor) is also connected to bus 806 via an interface, such as a video adapter 846. In addition to display device 844, computer 800 may include other peripheral output devices (not shown) such as speakers and printers.

Computer 800 is connected to a network 848 (e.g., the Internet) through a network interface or adapter 850, a modem 852, or other means for establishing communications over the network. Modem 852, which may be internal or external, is connected to bus 806 via serial port interface 842.

As used herein, the terms “computer program medium” and “computer-readable storage medium” are used to generally refer to media (e.g., non-transitory media) such as the hard disk associated with hard disk drive 814, removable magnetic disk 818, removable optical disk 822, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 832 and other program modules 834) may be stored on the hard disk, magnetic disk, optical disk, ROM, or RAM. Such computer programs may also be received via network interface 850 or serial port interface 842. Such computer programs, when executed or loaded by an application, enable computer 800 to implement features of embodiments discussed herein. Accordingly, such computer programs represent controllers of the computer 800.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
determine an extent to which an input-output pair corresponds to a goal of an agentic artificial intelligence (AI) flow that is implemented by a plurality of AI sub-agents in an agentic AI system, the input-output pair comprising an AI input that is provided as an input to the agentic AI system and an AI response that is received as an output of the agentic AI system in response to the AI input;
determine extents to which intermediate input-output pairs of the AI sub-agents correspond to sub-tasks in the agentic AI flow that the AI sub-agents are responsible for performing, the intermediate input-output pairs comprising inputs to the AI sub-agents and outputs that are received from the AI sub-agents in response to the inputs;
assign scores to the AI sub-agents using the extent to which the input-output pair corresponds to the goal of the agentic AI flow and the extents to which the intermediate input-output pairs of the AI sub-agents correspond to the sub-tasks that the AI sub-agents are responsible for performing; and
as a result of a first score that is assigned to a first AI sub-agent being less than a threshold score, increase the extent to which the intermediate input-output pair of the first AI sub-agent corresponds to a first sub-task that the first AI sub-agent is configured to perform by reconfiguring an AI algorithm that defines the first AI sub-agent, wherein the AI sub-agents comprise the first AI sub-agent, wherein the scores comprise the first score.

2. The system of claim 1, wherein the extent to which the input-output pair corresponds to the goal of the agentic AI flow takes into consideration at least one of the following:
a first number of hallucinations that are comprised in the AI response; or
a second number of instances of required information that are omitted from the AI response, wherein the instances of the required information are instances of information that are required to achieve the goal of the agentic AI flow.

3. The system of claim 1, wherein the computer-executable instructions are executable by the processor system to at least:
determine clarity of the AI response by analyzing the AI response with reference to a clarity standard; and
determine the extent to which the input-output pair corresponds to the goal of the agentic AI flow by taking into consideration the clarity of the AI response.

4. The system of claim 1, wherein the computer-executable instructions are executable by the processor system to at least:
determine usefulness of the AI response by analyzing the AI response with reference to a usefulness standard; and
determine the extent to which the input-output pair corresponds to the goal of the agentic AI flow by taking into consideration the usefulness of the AI response.

5. The system of claim 1, wherein an extent to which an intermediate input-output pair of an AI sub-agent corresponds to a sub-task in the agentic AI flow that the AI sub-agent is responsible for performing takes into consideration at least one of the following:
whether an output that is received from the AI sub-agent in response to an input to the AI sub-agent comprises an error;
a first number of hallucinations that are comprised in an output that is received from the AI sub-agent in response to an input to the AI sub-agent; or
a second number of instances of required information that are omitted from an output that is received from the AI sub-agent in response to an input to the AI sub-agent, wherein the instances of the required information are instances of information that are required to complete a sub-task in the agentic AI flow that the AI sub-agent is responsible for performing.

6. The system of claim 1, wherein the computer-executable instructions are executable by the processor system to at least:
determine clarity of the outputs that are received from the AI sub-agents by analyzing the outputs that are received from the AI sub-agents with reference to a clarity standard; and
determine the extents to which the intermediate input-output pairs of the AI sub-agents correspond to the sub-tasks in the agentic AI flow that the AI sub-agents are responsible for performing by taking into consideration the clarity of the outputs that are received from the AI sub-agents.

7. The system of claim 1, wherein the computer-executable instructions are executable by the processor system to at least:
determine usefulness of the outputs that are received from the AI sub-agents by analyzing the outputs that are received from the AI sub-agents with reference to a usefulness standard; and
determine the extents to which the intermediate input-output pairs of the AI sub-agents correspond to the sub-tasks in the agentic AI flow that the AI sub-agents are responsible for performing by taking into consideration the usefulness of the outputs that are received from the AI sub-agents.

8. The system of claim 1, wherein the computer-executable instructions are executable by the processor system to at least:
perform an evaluation of an effectiveness with which an invocation path, which is utilized by the agentic AI system to implement the agentic AI flow, achieves the goal of the agentic AI flow by analyzing attributes of the invocation path, the attributes of the invocation path comprising operations performed by the AI sub-agents to execute sub-tasks in the agentic AI flow that the AI sub-agents are responsible for executing and tools utilized by the AI sub-agents to perform at least a subset of the operations; and
assign the scores to the AI sub-agents using the extent to which the input-output pair corresponds to the goal of the agentic AI flow, the extents to which the intermediate input-output pairs of the AI sub-agents correspond to the sub-tasks that the AI sub-agents are responsible for performing, and the evaluation of the effectiveness with which the invocation path achieves the goal of the agentic AI flow.

9. The system of claim 8, wherein the attributes of the invocation path further comprise an order of the operations performed by the AI sub-agents to execute the sub-tasks in the agentic AI flow that the AI sub-agents are responsible for executing.

10. The system of claim 8, wherein the computer-executable instructions are executable by the processor system to perform the evaluation of the effectiveness with which the invocation path achieves the goal of the agentic AI flow by determining whether identified operations, which are comprised in the operations performed by the AI sub-agents, cause the invocation path to comprise an iterative loop.

11. The system of claim 8, wherein the computer-executable instructions are executable by the processor system to at least:
perform the evaluation of the effectiveness with which the invocation path, which is established by a controller AI sub-agent that coordinates execution of the AI sub-agents and that is comprised in the agentic AI system, achieves the goal of the agentic AI flow;
receive a description of the invocation path from the controller AI sub-agent;
perform a second evaluation of a completeness of the description of the invocation path, which is received from the controller AI sub-agent; and
assign a completeness score to the controller AI sub-agent as a result of the second evaluation, the completeness score corresponding to the completeness of the description of the invocation path.

12. A method implemented by a computing system, the method comprising:
performing an evaluation of an effectiveness with which an invocation path, which is utilized by a plurality of artificial intelligence (AI) sub-agents in an agentic AI system to implement an agentic AI flow, achieves a goal of the agentic AI flow by analyzing attributes of the invocation path, the attributes of the invocation path comprising operations performed by the AI sub-agents to complete sub-tasks in the agentic AI flow that the AI sub-agents are responsible for completing and tools utilized by the AI sub-agents to perform at least a subset of the operations;
assigning a score to the invocation path using the evaluation of the effectiveness with which the invocation path achieves the goal of the agentic AI flow; and
as a result of the score that is assigned to the invocation path being less than a threshold score, increasing the effectiveness with which the invocation path achieves the goal of the agentic AI flow by reconfiguring the invocation path, which is utilized by the plurality of AI sub-agents to implement the agentic AI flow.

13. The method of claim 12, wherein the attributes of the invocation path further comprise an order of the operations performed by the AI sub-agents to complete the sub-tasks in the agentic AI flow that the AI sub-agents are responsible for completing.

14. The method of claim 12, wherein performing the evaluation of the effectiveness with which the invocation path achieves the goal of the agentic AI flow comprises:
determining that identified operations, which are comprised in the operations performed by the AI sub-agents, cause the invocation path to comprise an iterative loop; and
wherein reconfiguring the invocation path comprises:
removing the iterative loop from the invocation path by reconfiguring an AI algorithm that defines a first AI sub-agent that performs at least a subset of the identified operations.

15. The method of claim 12, wherein performing the evaluation of the effectiveness with which the invocation path achieves the goal of the agentic AI flow comprises:
performing the evaluation of the effectiveness with which the invocation path, which is established by a controller AI sub-agent that coordinates execution of the AI sub-agents and that is comprised in the agentic AI system, achieves the goal of the agentic AI flow; and
wherein the method further comprises:
receiving a description of the invocation path from the controller AI sub-agent;
determining a completeness of the description of the invocation path, which is received from the controller AI sub-agent, by analyzing the description of the invocation path; and
causing the controller AI sub-agent to increase the completeness of the description of the invocation path by reconfiguring a designated AI algorithm that defines the controller AI sub-agent.

16. The method of claim 12, wherein an AI algorithm that defines a first AI sub-agent, which is comprised in the AI sub-agents, is configured to utilize an identified tool to perform a designated operation to complete a designated sub-task in the agentic AI flow that the first AI sub-agent is responsible for completing; and
wherein reconfiguring the invocation path comprises:
reconfiguring the AI algorithm, which defines the first AI sub-agent, to utilize a designated tool, in lieu of the identified tool, to perform the designated operation to complete the designated sub-task in the agentic AI flow that the first AI sub-agent is responsible for completing.

17. The method of claim 12, wherein reconfiguring the invocation path comprises:
replacing an identified AI sub-agent, which is comprised in the AI sub-agents, with a replacement AI sub-agent.

18. The method of claim 12, further comprising:
determining extents to which intermediate input-output pairs of the AI sub-agents correspond to the sub-tasks in the agentic AI flow that the AI sub-agents are responsible for completing, the intermediate input-output pairs comprising inputs to the AI sub-agents and outputs that are received from the AI sub-agents in response to the inputs;
wherein assigning the score to the invocation path comprises:
assigning the score to the invocation path using the evaluation of the effectiveness with which the invocation path achieves the goal of the agentic AI flow and the extents to which the intermediate input-output pairs of the AI sub-agents correspond to the sub-tasks in the agentic AI flow that the AI sub-agents are responsible for completing.

19. A computer program product comprising a computer-readable storage medium having instructions recorded thereon for enabling a processor-based system to perform operations, the operations comprising:
determining an extent to which an input-output pair corresponds to a goal of an agentic artificial intelligence (AI) flow that is implemented by a plurality of AI sub-agents in an agentic AI system, the input-output pair comprising an AI input that is provided as an input to the agentic AI system and an AI response that is received as an output of the agentic AI system in response to the AI input;
performing an evaluation of an effectiveness with which an invocation path, which is utilized by the agentic AI system to implement the agentic AI flow, achieves the goal of the agentic AI flow by analyzing attributes of the invocation path, the attributes of the invocation path comprising operations performed by the AI sub-agents to complete sub-tasks in the agentic AI flow that the AI sub-agents are responsible for completing and tools utilized by the AI sub-agents to perform at least a subset of the operations;
assigning scores to the AI sub-agents using the extent to which the input-output pair corresponds to the goal of the agentic AI flow and the evaluation of the effectiveness with which the invocation path achieves the goal of the agentic AI flow; and
as a result of a first score that is assigned to a first AI sub-agent, which is comprised in the AI sub-agents, being less than a threshold score, increasing the effectiveness with which the invocation path achieves the goal of the agentic AI flow by replacing the first AI sub-agent with a replacement AI sub-agent, wherein the scores comprise the first score.

20. The computer program product of claim 19, wherein the first AI sub-agent is configured to utilize an identified tool to perform a designated operation to complete a designated sub-task in the agentic AI flow; and
wherein the operations comprise:
configuring the replacement AI sub-agent to utilize the identified tool to perform the designated operation to complete the designated sub-task, which the replacement AI sub-agent is responsible for completing; or
configuring the replacement AI sub-agent to utilize a designated tool, in lieu of the identified tool, to perform the designated operation to complete the designated sub-task, which the replacement AI sub-agent is responsible for completing.
